(19) United States
(12) Patent Application Publication
(10) Pub. No.: US 2026/0346869 A1
(43) Pub. Date: Nov. 5, 2026

(54) POSE INITIALIZATION OPTIMIZATION FOR IMPROVED LOCALIZATION

(71) Applicant: Zoox, Inc., Foster City, CA (US)

(72) Inventors: Taylor Andrew Arnicar, Freemont, CA (US); Brice Rebsamen, Bouc-Bel-Air (FR)

(21) Appl. No.: 19/742,418

(22) Filed: Jul. 15, 2026

Related U.S. Application Data
(63) Continuation of application No. 18/590,622, filed on Feb. 28, 2024, now Pat. No. 12,709,293.

(51) Int. Cl. B60W 60/00; B60W 50/02; B60W 50/032

(52) U.S. Cl. CPC B60W 60/001; B60W 50/0205; B60W 50/032; B60W 2050/0215; B60W 2554/20; B60W 2556/40

(57) ABSTRACT

In order to operate reliably and effectively, an autonomous vehicle may at least partially rely on accurately determining an initial position and orientation of the vehicle within the environment. Without an accurate localization of the vehicle’s location, position, and orientation in an environment, the vehicle’s perception and/or planning components may be hindered, thereby reducing the effectiveness and/or safety of the vehicle. Techniques of the disclosure herein are related to initializing a localization component of a vehicle.

### CROSS REFERENCE TO RELATED APPLICATIONS

This patent application is a continuation of and claims priority to U.S. Patent Application No. 18/590,622, filed Feb. 28, 2024, which is fully incorporated herein by reference.

### BACKGROUND

In order to operate reliably and effectively, an autonomous vehicle may at least partially rely on accurately detecting where the autonomous vehicle is within the environment, i.e., a localization of the autonomous vehicle. Autonomous vehicles may use this localization and sensor data received by the autonomous vehicle to plan operation of the vehicle and predict an outcome of the vehicle’s operations. Without an accurate localization of the vehicle’s location, position, and orientation in an environment, the vehicle’s perception and/or planning components may be hindered, thereby reducing the effectiveness and/or safety of the vehicle.

### BRIEF DESCRIPTION OF THE DRAWINGS

The detailed description is described with reference to the accompanying figures. In the figures, the left-most digit(s) of a reference number identify the figure in which the reference number first appears. The same reference numbers in different figures indicate similar or identical items.

FIG. 1 illustrates an example scenario in which an autonomous vehicle may receive sensor data associated with a pose initialization location that may be used to localize the vehicle within the vehicles’ environment, in accordance with one or more implementations of the disclosure.

FIGS. 2A and 2B illustrate a pictorial flow diagram of an example process for initializing a localization component.

FIG. 3 illustrates a pictorial flow diagram of an example process for generating a new pose initialization location based at least in part on comparing map data at a location or simulating sensor data at the location with map data at another location or a simulation of sensor data received at the other location.

FIG. 4 depicts a block diagram of an example system for implementing various techniques described herein.

### DETAILED DESCRIPTION

As discussed above, autonomous vehicles may rely at least partially on accurately determining their relative position and orientation (collectively referred to herein as pose data) within their surrounding environment to operate reliably, safely, and effectively. Such vehicles may include a localization component that may receive sensor data from one or more sensors and may determine and update the vehicle’s precise pose data based on that sensor data. For example, the vehicle may use an initial estimate of the vehicle’s pose within the environment to determine a displacement from that pose based on inertial sensor data; wheel encoder data; fitting camera, lidar, and/or radar data to map data of the environment, and/or the like. Without a sufficiently accurate initial pose, a vehicle may inaccurately track progress of the vehicle in the environment and/or inaccurately determine a relative pose of the vehicle in the environment, which may result in a planning component of the vehicle that relies on such data to determine a trajectory for the vehicle that is unsafe or inefficient.

The techniques (e.g., hardware, software, machine-learned model(s), a combination thereof) discussed herein may comprise periodically determining an initial pose of the vehicle, which is referred to herein as an initial localization and may practically function as a starting point from which the vehicle may determine the vehicles’ progress and/or as a probabilistic prior for machine-learned model(s) of the vehicle that condition their output on an assumed starting point of the vehicle. Successful initial localization may improve the accuracy of the vehicle’s detection of objects around it or may improve the safety and reliability of operation associated with the vehicle’s perception and/or planning components. Aspects of this disclosure relate to techniques to optimize and expedite the initial localization procedure.

In some examples, a pose initialization procedure may comprise comparing a vehicle’s sensor data to map data of one or more stored pose initialization locations. The vehicle may use this comparison to determine which pose initialization location the vehicle is located at. For example, the vehicle may determine an indicator of a fit of the sensor data to map data indicated by a particular pose initialization location, such as determining a confidence score or average Euclidean distance between sensor data points received by the vehicle and surface(s) indicated by map data associated with the particular pose initialization location. The vehicle may determine that it is located at a pose initialization location by determining that the average Euclidean distance (or another measure of comparison discussed herein, such as a confidence score) is less than an average Euclidean distance threshold (or for a confidence score, above a confidence score threshold) or is the minimum average Euclidean distance (or maximum confidence score) from among multiple averages/confidence scores determined by comparing the sensor data to different pose initialization locations’ map data. In some examples, a region, such as a city or a sub-region thereof, may include a set of pose initialization locations. The vehicle may determine a sub-set of these pose initialization locations that are within a threshold distance of an estimated location of the vehicle. The vehicle may determine that estimated location based at least in part on sensor data (e.g., a GPS signal or any of the other techniques described herein) or a stored location of the vehicle indicating a last location determined by the vehicle, such as before the vehicle was powered off, entered a different mode, or the like.

In some examples, the vehicle may trigger a pose initialization based at least in part on detecting an event. For instance, after a reboot of various software and/or hardware components or after transitioning from a low power or low operations mode, the vehicle may execute a pose initialization. Similarly, after a vehicle component or sensor is impaired (e.g., a sensor is obscured or impaired in transit, an object impacts a portion of the vehicle) or otherwise has a component or sensor failure, the vehicle may re-trigger a pose initialization to correct or mitigate any errors in the vehicles’ pose or perception, planning, or localization components. Vehicles may also trigger a pose initialization procedure when manually instructed to do so by a remote operator, for example, or may do so after the passage of a threshold amount of time in order to maintain an accurate and precise understanding of the vehicles’ pose. As discussed in more detail below, there are many events and/or situations where a pose initialization may be triggered, and the examples noted are not exhaustive.

Once a pose initialization trigger event is detected, a vehicle may determine whether the vehicles’ prior pose initialization data is still valid. For example, when a vehicle enters an operational mode after charging or otherwise, the vehicle may first determine whether the pose data that was collected or determined before it entered a low operation or low power mode is still accurate. The vehicle may do so by comparing the last sensor data it received with sensor data of the vehicle’s surroundings and/or map data to determine a confidence score associated with the similarities and/or differences. If the confidence score meets or exceeds a threshold confidence score, the vehicle may use the stored pose as its initial pose (e.g., for further localization, perception, and/or planning operations of the vehicle). Additionally or alternatively, the stored pose data may be used to determine an estimated location of the vehicle that can be used to determine a subset of pose initialization locations within a threshold distance of the vehicle. The vehicle may either determine that the vehicle is already located at one of these pose initialization locations or may move the vehicle to an estimated closest pose initialization location of the subset to execute the pose initialization operations described herein.

In an additional or alternative instance, if a vehicle is towed and/or maneuvered while it is powered off or in a low operation mode or low power state, or if an operator manually maneuvers a vehicle outside of a specified map radius, the stored pose and/or location data may no longer be valid. For example, if a vehicle powered off or went into a low operation mode or low power state in position A at location one but powers on or otherwise enters an operational mode in position B at location two, the vehicle’s confidence score associated with its saved pose and/or location data may fall below a threshold confidence score, thus indicating that the vehicle’s saved pose data is invalid or otherwise inaccurate. In such a situation, the vehicle may re-initialize its pose and/or location in order to reliably and safely navigate in the environment. To do so, the vehicle may determine its estimated location without the use of the vehicles stored location and pose data. If the last stored location and/or pose of the vehicle is sufficiently dissimilar to the vehicle’s location and/or surroundings after powering on or otherwise entering an operational mode (e.g., as may be indicated by a confidence score that is below a threshold, an average Euclidean distance that is above a threshold, a GPS signal that indicates a location different from a stored location), or if the vehicle lacks a sufficient confidence score associated with its location and/or pose, the vehicle may determine its estimated location. Location data may comprise global positioning satellite (GPS) data, compass data, and/or the like, as discussed in more detail below.

After receiving data associated with the vehicle’s estimated location, such as sensor data and/or perception data, the vehicle may then determine a subset of pose initialization locations within a radius of the estimated location. Pose initialization locations may be located throughout a city or environment. For instance, they may be located at or near charging locations, in or around maintenance and/or services stations, at a command/control center, or other accessible locations in an environment, such as specific parking spots. As discussed further below, pose initialization locations may be predetermined candidate locations with unique and/or distinct surroundings (as determined by a sufficient difference between map data associated with the different pose initialization locations) and characteristics such that a vehicle can effectively compare sensor indicating the vehicle’s surroundings to map data associated with the pose initialization location in order to accurately localize. The vehicle may receive sensor data associated with the vehicles estimated location, and then search within a radius or an expanding radius (e.g., first a radius of 10 meters, then 50 meters, then 100 meters, and so on) until the vehicle determines a subset of candidate pose initialization locations within the radius or expanded radius. In another example, the vehicle may search a threshold radius (e.g., 50 meters or 100 meters) to determine a set of candidate pose initialization locations within that radius. In another example, the vehicle may receive a subset of candidate pose initialization locations from a superset that may be provided by a remote operator or a retrievable database that may be based at least in part on the vehicle’s estimated location.

In an alternate scenario where the saved pose data is invalid or inaccurate and the vehicle is also unable to receive location data (e.g., due to a lack of network connectivity, inclement weather, one or more compromised components, tall buildings and/or a convoluted environment), the vehicle may use its last stored location to estimate its current location and/or to determine a set of candidate pose initialization locations within a region near the last stored location. For example, if a vehicle is located in a tunnel and both the vehicle’s saved location and pose data is invalid and it is unable to receive estimated location data, the vehicle may search an area around its last saved location to determine a set of candidate pose initialization locations.

The vehicle may then determine which pose initialization location of the set of pose initialization locations it is located at or nearest to. To do this, the vehicle may receive second sensor data associated with one or more features/surfaces of its environment from one or more sensors. The one or more sensors may include a location sensor (e.g., a global positioning system (GPS) sensor), an inertia sensor (e.g., an accelerometer sensor, a gyroscope sensor, etc.), a depth position sensor (e.g., a lidar sensor, a radar sensor, a sonar sensor, a time of flight (ToF) camera, a depth camera, an ultrasonic and/or sonar sensor, and/or other depth-sensing sensor), an image sensor (e.g., a camera), an audio sensor (e.g., a microphone), and/or any combination thereof. For example, the vehicle may receive lidar data from one or more lidar sensors associated with the vehicle. This lidar data may include a set of data points, also referred to herein as a point cloud, wherein an individual lidar point may indicate a distance from the sensor to a surface in the environment. In some examples, such lidar data may be projected into or converted to a voxel space. Additionally or alternatively, the vehicle may receive image sensor data of the objects/features/surfaces of the environment around the vehicle. Using the point cloud received from the lidar sensors or the images received from the image sensors as in the above examples, the vehicle may then compare the second sensor data to the surfaces and/or features indicated by map data of individual pose initialization locations of the subset of candidate pose initialization locations. By determining a difference between at least a portion of the second sensor data and a surface or feature indicated by map data at a particular pose initialization location, a confidence score for each of the pose initialization locations can be determined. For example, if the vehicle is at pose initialization location A, and pose initialization locations B and C are also part of the set of pose initialization locations, the vehicle may iteratively compare its second sensor data to the different map data associated with pose initialization locations A, B, and C. By determining a difference between at least a portion of the second sensor data and at least a portion of one or more surfaces/features indicated by map data of each of pose initialization locations A, B, and C, the vehicle may determine a higher confidence score associated with pose initialization location A relative to the confidence score it determines for pose initialization locations B and C. That is, the confidence score associated with pose initialization location A may meet or exceed a threshold confidence score based on the differences (and/or similarities) of the second sensor data and one or more surfaces/features indicated by map data, thus indicating that the vehicle is located at pose initialization location A, while the confidence score associated with pose initialization locations B and C may fail to meet or exceed the threshold confidence score.

Additionally or alternatively, the vehicle may iteratively determine a confidence score for each pose initialization location (using each pose initialization location’s map data and the second sensor data) until a confidence score for a particular pose initialization location satisfies a threshold confidence score (e.g., by meeting or exceeding the threshold confidence sore), thus indicating that the vehicle is likely located at the particular pose initialization location.

In some examples, a confidence score determined by the vehicle may further be based at least in part on a percentage of the second sensor data that is associated with static objects, as may be determined by a perception component of the vehicle based at least in part on the second sensor data. Prior to or simultaneously with determining a confidence score for each pose initialization location, a perception component of the vehicle may determine a percentage of the second sensor data associated with static objects. In such an example, the non-static (i.e., dynamic/capable of movement/capable of locomotion) objects such as pedestrians, vehicles, bicycles, and the like may be filtered out of the second sensor data to avoid impacting the determination of the confidence score associated with the pose initialization locations of the subset of pose initialization locations. In other words, since dynamic objects may be non-permanent and/or inconsistent, determining a confidence score for a pose initialization location may be more accurate and/or reliable when only the static objects of the second sensor data are compared to the surfaces/features of the pose initialization location indicated by the map data. In some examples, the confidence score may be capped or multiplied by a percentage of the second sensor data that is associated with static object(s).

Additionally, or alternatively, the vehicle may determine that the second sensor data includes a portion associated with an indicator. The indicator may be a unique identifier, such as a quick-response (QR) code, barcode, radio-frequency-identification (RFID) tag, or distinct or uniquely shaped object, associated with a particular pose-initialization location. For example, a charging station may display a unique QR code, such as on the ground beneath a vehicle positioned to use the charger or on a face of the charger. The vehicle may use an image sensor to capture sensor data representing the QR code. In some examples, a charging station or other location may include an RFID tag that vehicle 102 can use to determine pose and/or location information. In addition to or instead of receiving an estimated location and sensor data representing the surrounding environment, the vehicle may receive sensor data generated by scanning, reading, or capturing the indicator. The vehicle may use the sensor data to retrieve information associated with the pose-initialization location corresponding to the indicator. In another example, the vehicle may receive lidar or radar data representing a unique three-dimensional object in the environment, such as an art installation or distinctive building feature. The object may be associated with one or more pose-initialization locations. The vehicle may use the sensor data representing the object to determine the vehicle’s location and pose within the environment, thereby improving the effectiveness and reliability of a localization, planning, perception, and/or other vehicle component. For example, the vehicle may determine a global location and/or geolocation, expressed in any suitable coordinate frame, such as a map coordinate frame or vehicle coordinate frame, associated with the indicator. The vehicle may then use the second sensor data to determine the vehicle’s position relative to the indicator. The vehicle may use the relative position as an offset from the location associated with the indicator to determine a global position and/or orientation of the vehicle within the environment.

After a confidence score of a particular pose initialization location meets or exceeds a threshold confidence score, the vehicle may then determine its initial pose. The vehicle may determine its initial pose based at least in part on a geolocation and map data associated with a pose initialization location and a relative position of the vehicle, where the relative position of the vehicle may be based at least in part on the second sensor data. The second sensor data as discussed above may provide the vehicle with an accurate determination of its precise position and orientation within a pose initialization location. After determining an initial pose, the vehicle may localize itself with a localization component (e.g., using simultaneous localization and mapping (SLAM), or the like). For example, the localization component may determine a pose of the vehicle based at least in part on fitting the second sensor data to surfaces indicated by the map data associated with the pose initialization location. This may comprise iteratively changing the pose until the fit, average distance between the second sensor data points and the surface(s), and/or the like is below a threshold fit indication or average distance.

The pose initialization processes and procedures discussed herein increase the reliability and accuracy of a pose initialization, thereby improving the effectiveness of a vehicle’s localization system. An improved localization system allows a vehicle to predicate future operations of the vehicle on precise location and orientation within an environment. When a vehicle uses a more acute initial pose, it is better equipped to determine safe and effective controls for maneuvering in the environment. Employing pose initialization locations as discussed herein may reduce the time that a vehicle is inoperable, improve passenger safety by ensuring that a vehicle has a more definite/accurate determination of the vehicle’s location and pose, and/or expedite the initialization of the localization system, among other benefits contemplated herein.

### EXAMPLE SCENARIO

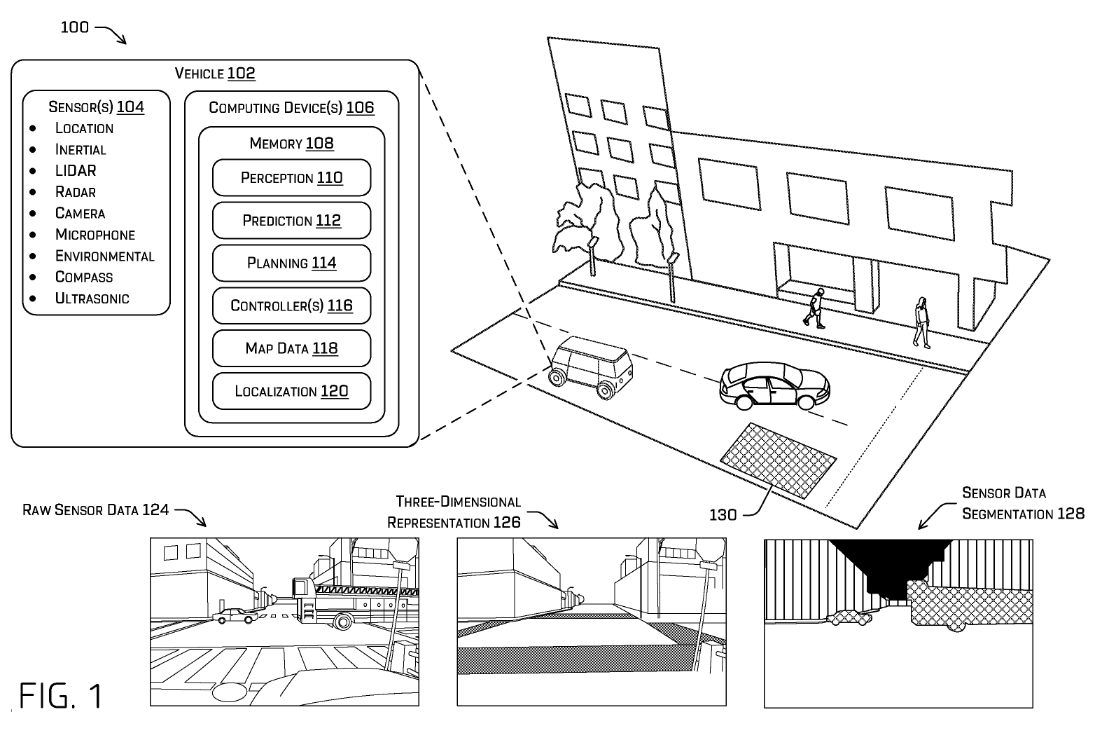

FIG. 1 illustrates an example scenario 100 including a vehicle 102. In some instances, the vehicle 102 may be an autonomous vehicle configured to operate according to a Level 5 classification issued by the U.S. National Highway Traffic Safety Administration (NHTSA). A Level 5 vehicle is capable of performing all safety-critical driving functions for an entire trip, without the driver or occupant being expected to control the vehicle at any time. In other examples, the vehicle 102 may be a fully or partially autonomous vehicle having any other level or classification. The techniques described herein are not limited to robotic vehicle control and may be applied to other fields, including mining, manufacturing, augmented reality, and the like. Although the vehicle 102 is depicted as a land vehicle, the vehicle 102 may alternatively be a spacecraft, watercraft, aircraft, or other type of vehicle.

According to the techniques discussed herein, the vehicle 102 may receive sensor data from sensor(s) 104 of the vehicle 102. For example, the sensor(s) 104 may include a location sensor (e.g., a global positioning system (GPS) sensor), an inertia sensor (e.g., an accelerometer sensor, a gyroscope sensor, etc.), a magnetic field sensor (e.g., a compass), a position/velocity/acceleration sensor (e.g., a speedometer, a drive system sensor), odometry data (which may be determined based at least in part on inertial measurements and/or an odometer of the vehicle 102), a depth position sensor (e.g., a lidar sensor, a radar sensor, a sonar sensor, a time of flight (ToF) camera, a depth camera, an ultrasonic and/or sonar sensor, and/or other depth-sensing sensor), an image sensor (e.g., a camera), an audio sensor (e.g., a microphone), and/or environmental sensor (e.g., a barometer, a hygrometer, etc.).

The sensor(s) 104 may generate sensor data, which may be received by computing device(s) 106 associated with the vehicle 102. However, in other examples, some or all of the sensor(s) 104 and/or computing device(s) 106 may be separate from and/or disposed remotely from the vehicle 102 and data capture, processing, commands, and/or controls may be communicated to/from the vehicle 102 by one or more remote computing devices via wired and/or wireless networks.

Computing device(s) 106 may comprise a memory 108 storing a perception component 110, a prediction component 112, a planning component 114, system controller(s) 116, map data 118, and/or a localization component 120. Although depicted in FIG. 1 for illustrative purposes, it is understood that the map data 118 may reside in/on a separate computing device (or otherwise) than any one or more of the other components, as discussed in more detail below.

In general, the perception component 110 may determine objects, features, and other characteristics of the environment surrounding the vehicle 102. The planning component 114 may determine how to operate the vehicle 102 based on information received from the perception component 110. For example, the planning component 114 may determine a trajectory based at least in part on perception data and/or other information, such as map data 118, localization information, or the like. The map data 118 may include a map generated according to the techniques described herein. The localization information may indicate the position of the vehicle 102 within the environment relative to the map and/or features detected by the perception component 110. In some examples, the perception component 110 may include a hardware and/or software pipeline having one or more graphics processing units (GPUs), machine-learning (ML) models, Kalman filters, and/or other components.

In some examples, the perception component 110 may receive sensor data from the sensor(s) 104 and determine data related to objects in the vicinity of the vehicle 102 (e.g., classifications associated with detected objects, instance segmentation(s), semantic segmentation(s), two and/or three-dimensional bounding boxes, tracks), route data that specifies a destination of the vehicle, a pose of the vehicle (e.g. position and/or orientation in the environment, which may be determined by or in coordination with a localization component), and/or map data 118. Map data 118 may comprise global map data that identifies characteristics of roadways, such as roadway curvature, configuration, locations, extents, etc.; static object(s); and/or the like. Additionally, or alternatively, map data 118 may comprise local map data that identifies characteristics of the environment determined based at least in part on sensor data. Such local map data may indicate locations and/or dimensions of buildings, trees, fences, fire hydrants, stop signs, and any other feature detectable in various sensor modalities, etc.

In some examples, the vehicle 102 may transmit sensor data to a remote computing device. The remote computing device may use the sensor data to generate map data 118 representing the environment. Additionally, or alternatively, the localization component 120 may generate at least a portion of the map data 118. For example, the localization component 120 may use a simultaneous localization and mapping (SLAM) technique based on the initial pose determined according to the techniques described herein. The map data 118 may include a two-dimensional and/or three-dimensional representation of the environment. The representation may be defined by a mesh, wire-frame model, polygons, surfels, or the like. Surfels may include polygons associated with respective colors and/or intensity values. The remote computing device may transmit the representation to the vehicle 102, which may use the representation to navigate the environment safely and efficiently. For example, the vehicle 102 may use the map data 118 to determine: the vehicle’s position within the environment; locations of drivable surface areas; locations of static objects; locations of drop-off areas; and locations of landmarks. The vehicle 102 may use these and other determinations to generate a trajectory for controlling its motion.

For the sake of simplicity, FIG. 1 depicts raw sensor data 124, which may include indications of objects, landmarks, characteristics, and/or other features detected near the vehicle 102. Although the raw sensor data 124 is illustrated as raw image-sensor data, any one or more of the sensors 104 may be used to obtain the raw sensor data 124. FIG. 1 also depicts a three-dimensional representation 126 of the map data 118. The three-dimensional representation 126 may depict static objects associated with the environment near the vehicle 102. As a nonlimiting example, the three-dimensional representation 126 may include indications of static features associated with the environment without including indications of dynamic features. Thus, for purposes of illustration, the three-dimensional representation 126 depicts only static objects and/or features near the vehicle 102. The three-dimensional representation 126 illustrates only a limited portion of the map data 118. The map data 118 may include more or fewer surfaces, objects, and/or other environmental features than those shown in the three-dimensional representation 126.

further depicts a sensor-data segmentation 128 of the raw sensor data 124 generated by the perception component 110. The perception component 110 may generate the sensor-data segmentation 128 using a machine-learned model configured to determine a confidence score for a portion of the raw sensor data 124. In some examples, the machine-learned model may determine multiple confidence scores for the same portion of the raw sensor data 124, with each confidence score corresponding to a different object classification. The machine-learned model may select the highest confidence score and the object classification associated with that score. The machine-learned model may then output the selected object classification for the corresponding portion of the raw sensor data 124 as part of the sensor-data segmentation 128. The object classifications may additionally or alternatively be associated with static or dynamic classifications. For example, classifications such as cyclist, vehicle, and pedestrian may be associated with dynamic objects, while classifications such as building, roadway, and signage may be associated with static objects. For purposes of illustration, the sensor-data segmentation 128 depicts dynamic objects using diagonal cross-hatching and static objects using vertical cross-hatching. However, various techniques may be used to identify and/or segment static and dynamic objects in an environment. These techniques may include masking, instance segmentation, semantic segmentation, and/or a matrix of confidence scores. For example, a mask may associate a value, such as 1 or 0, with a portion of the raw sensor data to indicate whether the perception component 110 determines that the portion represents a static object. As described in greater detail below, the perception component 110 may determine a confidence score for each portion of sensor data, such as a pixel, voxel, or group of pixels or voxels. The confidence score may correspond to an object or feature characteristic, such as whether the portion represents a static or dynamic object. In some examples, the localization component 120 may remove, mask, disregard, or otherwise avoid using a portion of the sensor data determined to be associated with one or more dynamic objects. For example, the localization component 120 may disregard the portion when one or more confidence scores associated with the portion meet or exceed a threshold confidence score.

In some examples, the pose initialization techniques discussed herein may be accomplished with just sensor data 124. In such examples, the pose initialization techniques discussed herein may be executed without the use of a three-dimensional representation 126 of map data 118 and/or a sensor data segmentation 128.

FIG. 1 further depicts an example pose initialization location 130. As shown, the pose initialization location 130 may be proximate one or more static and/or dynamic features in the environment. As discussed further below, a pose initialization location 130 may be added to a set of pose initialization locations based at least in part on the distinctiveness of the static features of the environment proximate the pose initialization location 130 compared to the static features of the environment associated with the other pose initialization locations in the set. Additionally, or alternatively, as discussed in more detail below, a pose initialization location 130 may be generated by a vehicle 102 prior to powering off or otherwise entering a low operation state. For illustrative purposes, pose initialization location 130 is depicted on a road near a crosswalk; however, as discussed in more detail below, pose initialization locations may be located anywhere a vehicle 102 may navigate (e.g., parking spaces in a parking lot, parking spaces proximate a road, warehouse facilities, charging stations/facilities, repair or services stations, a shoulder of a road, etc.).

In some examples, the perception component 110 may determine, based at least in part on sensor data, an object detection indicating an association of a portion of sensor data with an object in the environment. The object detection may indicate an object classification, a region of interest (ROI) identifying a portion of sensor data associated with the object, and/or a confidence score indicating a likelihood (e.g., posterior probability) that the object classification is correct and/or a confidence score that the ROI is accurate. For example, the ROI may include a portion of an image or radar data identified by an ML model or ML pipeline of the perception component 110 as being associated with the object, such as using a bounding box, mask, an instance segmentation, and/or a semantic segmentation. The object classifications determined by the perception component 110 may distinguish between different object types such as, for example, a passenger vehicle, a pedestrian, a bicyclist, a delivery truck, a semi-truck, traffic signage, and/or the like. In some examples, object detections may be tracked over time. For example, a track may associate two object detections generated at two different times as being associated with a same object and may comprise a historical, current, and/or predicted object position, velocity, acceleration, and/or heading of that object.

The data produced by the perception component 110 may be collectively referred to as perception data. Once the perception component 110 has generated perception data, the perception component 110 may provide the perception data to the localization component 120 and/or the planning component 114. The perception data may additionally or alternatively be stored in association with the sensor data as log data. This log data may be transmitted to the planning component 114, which may execute on the computing device(s) 106 and/or at a remote computing device (unillustrated in FIG. 1 for clarity).

In at least one example, the localization component 120 may include hardware and/or software configured to receive data from the sensor(s) 104 and/or perception data and determine a position, velocity, and/or orientation of the vehicle 102. For example, the localization component 120 may determine one or more of an x-position, y-position, z-position, roll, pitch, or yaw of the vehicle 102. The localization component 120 may include, request, and/or receive map data 118 representing an environment and may use the map data 118 to determine the location, velocity, and/or orientation of the autonomous vehicle within the environment. The localization component 120 may additionally or alternatively implement the pose-initialization techniques described herein. For example, the localization component 120 may determine that the vehicle 102 is at or near a pose-initialization location, such as pose-initialization location 130, including within a threshold distance of the pose-initialization location 130. The localization component 120 may retrieve a geolocation associated with the pose-initialization location 130 and use the map data 118 to determine the position of the vehicle 102 relative to that geolocation. The localization component 120 may use the relative position of the vehicle 102 and the geolocation associated with the pose-initialization location 130 to determine a geolocation and/or orientation of the vehicle 102, thereby establishing an initial pose of the vehicle 102. In some examples, the localization component 120 may track movement of the vehicle 102 from the initial pose using trajectories generated by the planning component 114, feedback from wheel encoder(s) and/or a steering rack of the vehicle 102, and/or other sensor data.

For example, the localization component 120 may track the progress of the vehicle 102 as the vehicle moves through the environment using a pose graph. The pose graph may include a series of poses associated with different times and/or distances traveled by the vehicle 102. While the vehicle 102 executes a trajectory, the sensor(s) 104 may collect sensor data, such as lidar data, radar data, image data, odometry data, inertial data, and/or other sensor data. The localization component 120 may generate the pose graph based at least in part on the odometry data, inertial data, and/or other sensor data, including camera, lidar, or radar data, and may associate the collected sensor data with respective nodes of the pose graph. Associating a set of sensor data with a pose node may indicate that the sensor data was collected within a particular time window and/or position range corresponding to the pose represented by the pose node. Additionally, or alternatively, the localization component 120 may fit sensor data to map data associated with a current estimated pose of the vehicle 102. This fitting may corroborate or correct the estimated pose and help ensure that the poses represented in the pose graph are accurate. In some examples, this iterative and ongoing determination of the poses of the vehicle 102 over time may be based at least in part on the initial pose determined by the localization component 120.

The planning component 114 may use perception data received from the perception component 110, the initial pose, and/or the pose graph generated by the localization component 120 to determine one or more trajectories, control the vehicle 102 along a path or route, and/or otherwise control operation of the vehicle 102. In other examples, one or more of these operations may be performed by other components. For example, localization may be performed by the localization component 120 based at least in part on perception data. For example, the planning component 114 may determine a route for the vehicle 102 from a first location to a second location. The planning component 114 may then generate, substantially concurrently and based at least in part on the perception data and/or pose graph, multiple candidate trajectories for controlling motion of the vehicle 102 along the route. The candidate trajectories may be generated according to a receding-horizon technique over a relatively short horizon, such as one microsecond or one-half second, and may account for detected objects and other environmental conditions. The planning component 114 may select one of the candidate trajectories as a trajectory for the vehicle 102 and use the selected trajectory to generate a drive-control signal. The drive-control signal may be transmitted to one or more drive components of the vehicle 102. For example, the trajectory may include instructions for the controller(s) 116 to actuate the drive components to produce a steering angle, steering rate, acceleration, and/or other vehicle operation. The resulting operation may determine a position, velocity, and/or acceleration of the vehicle 102. The trajectory may specify a target heading, target steering angle, target steering rate, target position, target velocity, target acceleration, and/or other target state for the controller(s) 116 to track. In some examples, the trajectory may include controls sufficient to operate the vehicle 102 over a time horizon, such as 5 milliseconds, 10 milliseconds, 100 milliseconds, 200 milliseconds, 0.5 seconds, 1 second, or 2 seconds, and/or over a distance horizon, such as 1 meter, 2 meters, 5 meters, 8 meters, or 10 meters.

In some examples, the controller(s) 116 may comprise software and/or hardware for actuating drive components of the vehicle 102 sufficient to track the trajectory. For example, the controller(s) 116 may comprise one or more proportional-integral-derivative (PID) controllers.

### EXAMPLE PROCESS

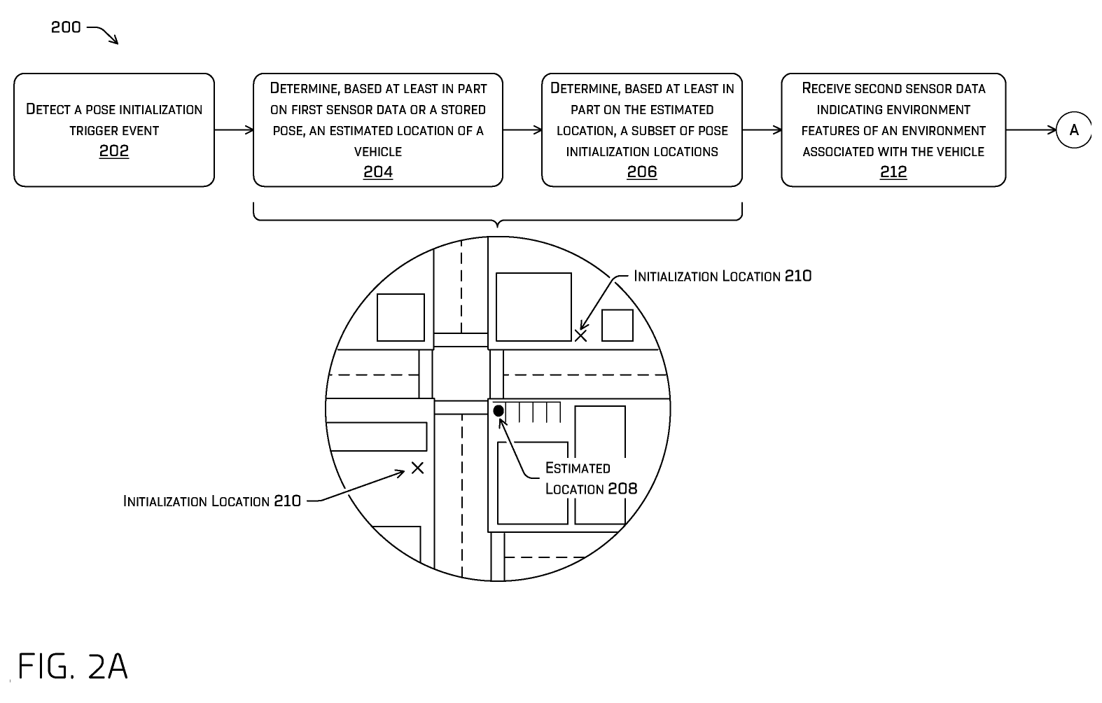

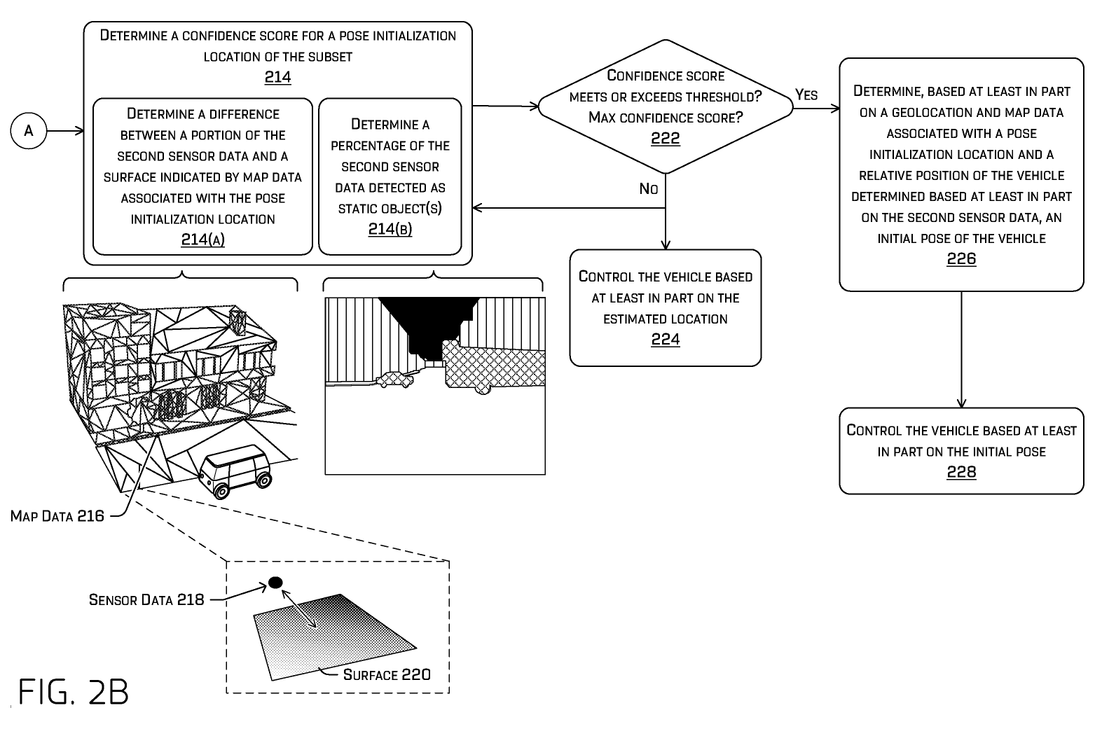

FIGS. 2A and 2B illustrates a pictorial flow diagram of an example process 200 for initializing a localization component 120. In some examples, the process 200 may be performed by a vehicle 102. The process 200, as well as other processes described herein, may be represented as a logical flow graph. Each operation in the flow graph may represent a sequence of operations implemented in hardware, software, or a combination thereof. When implemented in software, the operations may correspond to computer-executable instructions stored on one or more computer-readable storage media. When executed by one or more processors, the instructions may cause the processors to perform the described operations. Computer-executable instructions may include routines, programs, objects, components, data structures, machine-learned models, and/or other software elements configured to perform particular functions or implement particular data types. The order in which the operations are described is not intended to be limiting. Any number of the described operations may be omitted, combined, rearranged, or performed in parallel to implement the process 200.

Turning to FIG. 2A, at operation 202, the example process 200 may include detecting a pose-initialization trigger event. As discussed above, a vehicle 102 may initiate pose initialization in response to various events and/or conditions. For example, the vehicle 102 may initiate pose initialization after entering an operational mode or powering on following a transition from a low-power state or low-operations mode. In some examples, the vehicle 102 may initiate pose initialization after returning to a mission mode, such as after being powered off or operating in another mode, including a data-collection mode, network-mesh mode, diagnostic mode, or the like. The vehicle 102 may also initiate pose initialization after one or more hardware or software components powers on, such as after downloading an update or transitioning from a powered-off state to a powered-on state. In other examples, the vehicle 102 may initiate pose initialization after one or more components are damaged, impaired, or otherwise affected during transit. For example, a sensor may become obscured or impaired, or an object may impact a portion of the vehicle 102. The vehicle 102 may also initiate pose initialization in response to a component failure. In such circumstances, pose initialization may correct and/or mitigate errors associated with the pose of the vehicle 102 or with the perception component 110, planning component 114, and/or localization component 120

In other examples, the vehicle 102 may initiate pose initialization to calibrate one or more sensors 104. Calibration may include fusing, meshing, integrating, or otherwise aligning data associated with the sensors 104. The vehicle 102 may also initiate pose initialization to mitigate faults detected by the vehicle 102 or by one or more of the sensors 104. The vehicle 102 may further initiate pose initialization in response to detecting a charging event. For example, based on sensor data associated with engaging or disengaging a charging station or charging connection, the vehicle 102 may initiate pose initialization while connected to the charger and/or after disconnecting from the charger. In other examples, the vehicle 102 may detect a pose-initialization trigger event based at least in part on a change in the vehicle’s surroundings. Such changes may occur when the vehicle 102 enters or exits a parking garage, warehouse, tunnel, or other building or structure, or when the vehicle 102 enters or exits an alley or another constrained location. For example, the vehicle 102 may perform pose initialization after exiting an indoor parking garage and before navigating through the surrounding environment. The vehicle 102 may also initiate pose initialization in response to inclement weather or a change in weather conditions. For example, if heavy fog develops or the sun sets, the resulting change in visibility, brightness, or other environmental conditions may cause the vehicle 102 to initiate pose initialization. Similarly, if the vehicle 102 has been navigating under limited-visibility conditions, such as heavy rain, fog, or snow, the vehicle 102 may initiate pose initialization when visibility improves or otherwise changes. Additionally, or alternatively, the vehicle 102 may initiate pose initialization during or after a repair or diagnostic event. For example, the vehicle 102 may initiate pose initialization after sending or receiving diagnostic data or after undergoing a mechanical, electronic, or software repair. The repair may be performed remotely, manually, or using another technique.

A vehicle 102 may additionally or alternatively execute a pose initialization based at least in part on receiving instructions to do so. For instance, a remote operator/teleoperator may send data associated with instructions to one or more vehicles (e.g., which may include vehicle 102) to execute a pose initialization procedure after the passage of a threshold amount of time or may do so before the one or more vehicles enter an operational mode and/or begin to navigate in an environment. Such a list of events/situations/reasons for a vehicle 102 to initialize its pose is by no means exhaustive, and there are many other events/situations/reasons contemplated herein that a vehicle may execute a pose initialization.

At operation 204, the example process 200 may include determining, based at least in part on first sensor data and/or a stored pose, an estimated location 208 of the vehicle 102. In some examples, the vehicle 102 may determine the estimated location 208 using sensor data received from a global-positioning sensor, such as a GPS receiver. Additionally or alternatively, when the vehicle 102 enters an operational mode—such as after charging, powering on, exiting a low-operations or low-power mode, undergoing repairs, or otherwise resuming operation—the vehicle 102 may determine whether pose data collected or determined before the transition remains accurate. For example, the vehicle 102 may determine whether first sensor data, such as GPS data, indicates a position within a threshold distance of the position represented by the stored pose. The vehicle 102 may additionally or alternatively determine whether the first sensor data is consistent with map data associated with the stored pose. In some examples, the vehicle 102 may compare the first sensor data with map data associated with a location indicated by the stored pose to determine a confidence score. If the confidence score meets or exceeds a threshold confidence score or corresponds to a maximum confidence score, the vehicle 102 may use the stored pose as its initial pose for subsequent localization, perception, and/or planning operations. A confidence score that meets or exceeds the threshold, or corresponds to the maximum confidence score, may indicate that the vehicle 102 has the same or a sufficiently similar pose as before it entered the low-operations or low-power mode. Accordingly, the vehicle 102 may use the stored pose as its initial pose or, at least, use the stored pose to determine the estimated location 208.

In some examples, the vehicle 102 may determine that a confidence score associated with its estimated location 208 meets or exceeds a threshold, while a confidence score associated with its stored pose data fails to meet the threshold. This may indicate that the vehicle 102 can accurately determine its current estimated location 208, but that the stored pose data is no longer valid. In such examples, the vehicle 102 may use the estimated location 208 to generate a pose-initialization location 210 according to the techniques described herein. For example, before powering off or transitioning to a low-operations or low-power state, the vehicle 102 may store its estimated or precise location together with map data representing environmental features at that location. The stored location and associated map data may thereby define a unique pose-initialization location. When the vehicle 102 powers on or exits the low-operations or low-power state, it may use the stored location, map data, and/or sensor data to perform pose initialization at the previously generated pose-initialization location. This may allow the vehicle 102 to reinitialize even when the stored pose itself is no longer sufficiently reliable. In addition, when multiple vehicles, such as vehicles in a fleet, initiate pose initialization simultaneously or within a short period, vehicle-specific pose-initialization locations generated before powering off or entering a low-operations state may reduce or eliminate queuing. Each vehicle may perform pose initialization independently using its respective pose-initialization location. Using vehicle-specific pose-initialization locations may also reduce the total number of shared pose-initialization locations needed to initialize a fleet of vehicles.

Additionally, or alternatively, the vehicle 102 may determine its estimated location 208 based at least in part on first sensor data obtained from one or more sensors 104. For example, the stored location and/or pose data may no longer be accurate if the vehicle 102 is towed or otherwise repositioned while powered off or operating in a low-operations or low-power mode. Stored data may also become inaccurate if an operator manually or remotely maneuvers the vehicle 102 beyond a specified map radius. For instance, if an operator manually or remotely controls the vehicle 102 while it is powered off, the vehicle 102, upon powering on, may determine a confidence score associated with its stored pose data. If the confidence score falls below a confidence-score threshold, the vehicle 102 may determine that the stored pose data is invalid or otherwise unreliable. In such examples, the vehicle 102 may obtain first sensor data from one or more sensors 104 to determine the estimated location 208. The first sensor data may include location-related data, such as compass data, global positioning satellite (GPS) data, inertial-measurement data, and/or other sensor data. The vehicle 102 may use the first sensor data to estimate its current location. Using first sensor data from the sensors 104 may therefore assist the vehicle 102 in determining the estimated location 208 when the stored pose data is invalid, outdated, or otherwise insufficiently reliable.

In at least some examples, the first sensor data may represent one or more features of the environment proximate to the vehicle 102. The features may include an indicator or other unique identifier associated with a particular location. For example, the indicator may include a retrievable identification number, quick-response (QR) code, barcode, other fiducial marker, or a code transmitted by a network device. The transmitted code may use, for example, Near Field Communication (NFC), Radio Frequency Identification (RFID), ultra-high-frequency radio such as Bluetooth®, Wi-Fi, a wireless local area network (WLAN), a low-rate wireless personal area network (LR-WPAN), or a Long-Range Wide Area Network. The indicator or unique identifier may be associated with a location in a database accessible to the vehicle 102, such as a database stored in vehicle memory or accessible through an application programming interface (API). As a more concrete example, the vehicle 102 may receive image sensor data depicting a QR code located near the vehicle 102. The QR code may be affixed to an object having an associated geolocation or other location information recorded in the accessible database. After identifying the QR code, the vehicle 102 may determine the associated geolocation and navigate to, or otherwise position itself relative to, that geolocation to perform pose initialization according to the techniques described herein.

In other examples, the first sensor data may be received from one or more emitters, such as sound emitters, including ultrasonic emitters, or electromagnetic emitters. The electromagnetic emitters may emit millimeter-wave, radio-frequency, microwave, infrared, visible-light, and/or other signals that the vehicle 102 may use to determine an estimated location 208. In such examples, the vehicle 102 may determine the estimated location 208 based at least in part on a location of one or more electromagnetic emitters. The vehicle 102 may use map data 118, first sensor data, and/or other information to determine the locations of the emitters. The vehicle 102 may also receive second sensor data associated with the emitters, such as data from an ultrasonic sensor. The first sensor data associated with the emitters may be encoded with information that the vehicle 102 can use to determine the estimated location 208. The encoded information may include an estimated location, an estimated pose, and/or a precise pose. The vehicle 102 may additionally or alternatively authenticate the first sensor data received from the emitters before using the data for localization. As a more concrete example, a warehouse depot or charging station may include one or more ultrasonic emitters. The vehicle 102 may receive first sensor data from one or more ultrasonic sensors and perform an ultrasonic handshake with the emitters located at or near the warehouse depot or charging station. The first sensor data may include, or otherwise indicate, an estimated location 208 and/or an estimated or precise pose of the vehicle 102 relative to one or more of the ultrasonic emitters. The vehicle 102 may use the indicated location and/or pose to perform pose initialization according to the techniques described herein.

In some examples, the vehicle 102 may determine an estimated location 208 based at least in part on a cellular or network triangulation. In such an example, one or more sensor(s) 104 of the vehicle 102 may transmit or receive data associated with an estimated location 208 and/or an estimated distance from one or more cell towers or one or more network devices. For instance, the vehicle 102 may receive and/or transmit (e.g., ping) data to/from one or more network devices or cell towers, and based at least in part on a distance, time, latency, strength (e.g., signal-to-noise ratio, power) of a signal from a network transmitter or similar characteristic of the data transmission to/from the one or more network devices or cell towers, the vehicle 102 may determine the vehicle’s estimated location 208.

At operation 206, example process 200 may include determining, based at least in part on the estimated location 208 of the vehicle 102, a subset of pose initialization locations. As shown in FIG. 2A, pose initialization locations may be predetermined locations in a city, region, and/or an environment where a vehicle 102 may execute a pose initialization. For example, pose initialization locations may be located at or near charging stations/bases, in or around maintenance and/or service stations, at a command/control center, or at other accessible locations in an environment, such as specific parking spots. Pose initialization locations may be predetermined locations with unique and/or distinct features/characteristics/surroundings (as determined by a sufficient difference between map data 118 associated with the different pose initialization locations, discussed in more detail below) such that a vehicle 102 may compare sensor data of the vehicle’s proximate environment with map data 118 of the predicted surroundings of the pose initialization location 210 in order to accurately localize. In some examples, each pose initialization location may have a unique geolocation and unique map data associated therewith that a vehicle can use to determine a relative global pose of the vehicle.

As a more concrete example, a pose-initialization location 210 may be positioned between two buildings having distinctive features. These features may enable the vehicle 102 to distinguish the pose-initialization location 210 from nearby locations associated with either building. In another example, the pose-initialization location 210 may be positioned at or near a location where the vehicle 102 is frequently present, such as a charging location or a maintenance or service location. Additionally, or alternatively, before powering off or entering a low-operations or low-power mode, the vehicle 102 may generate a vehicle-specific pose-initialization location 210 for use when the vehicle 102 powers on or returns to an operational mode. For example, before powering off, the vehicle 102 may store map data 118 and/or sensor data representing environmental features proximate to the vehicle 102. The stored data may define a pose-initialization location 210 associated with the vehicle 102. When the vehicle 102 powers on, reboots, or otherwise enters an operational state, it may compare newly acquired map data 118 and/or sensor data with the stored map data 118 and/or sensor data representing the surrounding environment. Based on the comparison, the vehicle 102 may determine a confidence score indicating the accuracy or reliability of the saved pose data. The vehicle 102 may use the confidence score to determine whether the saved pose data remains valid and whether to use the vehicle-specific pose-initialization location 210 for pose initialization.

Additionally, or alternatively, to determine a subset of pose-initialization locations, the vehicle 102 may receive data associated with, and/or determine, its estimated location 208. The vehicle 102 may then incrementally search the surrounding environment using an expanding search radius. For example, the vehicle 102 may search within an initial radius of 10 meters, followed by radii of 50 meters, 100 meters, or other progressively larger distances. The vehicle 102 may continue expanding the search radius until it identifies a subset of candidate pose-initialization locations. In some examples, the vehicle 102 may expand the radius until the number of candidate pose-initialization locations meets or exceeds a threshold number. As illustrated in FIG. 2A, the vehicle 102 may initially search within a predetermined radius—such as 10 meters, 100 meters, or 300 meters—of the estimated location 208 to identify pose-initialization locations within that distance. If the vehicle 102 does not identify any pose-initialization locations, or identifies locations that are inaccessible or otherwise unsuitable, the vehicle 102 may increase the search radius and repeat the search. The vehicle 102 may repeat this process one or more times until it identifies a suitable subset of pose-initialization locations.

Additionally or alternatively, the vehicle 102 may receive a subset of pose-initialization locations from a set of pose-initialization locations maintained by a remote operator or a retrievable database. The subset may be selected based at least in part on the estimated location 208 of the vehicle 102. In some examples, the vehicle 102 may request the subset after failing to identify suitable pose-initialization locations locally. In other examples, retrieving the subset from a remote source may be faster or more efficient than performing a local search. The vehicle 102 may also be unable to determine its estimated location effectively. This may occur, for example, because of inclement weather, a lack of network connectivity, one or more impaired components, tall buildings, or a complex or constrained environment. In such circumstances, the vehicle 102 may transmit a request to a remote computing device associated with a remote operator and/or access a database containing pose-initialization-location data. The subset may be selected based at least in part on the availability of individual pose-initialization locations. A pose-initialization location may be considered available when the vehicle 102 is permitted and physically able to use the location. For example, availability may depend on whether: Navigable roadways provide a feasible route to the pose-initialization location 210; A legally available parking space exists at the pose-initialization location 210; and Sufficient physical space is available, based on current or recently updated map data 118, including consideration of dynamic objects that may occupy the area. Accordingly, a pose-initialization location 210 may be removed from the subset if it is inaccessible or otherwise unsuitable. For example, if the pose-initialization location 210 is within a construction zone and no navigable roads lead to it, the vehicle 102 or the remote computing device may exclude that location from the subset.

Additionally, or alternatively, if the vehicle 102 is unable to receive location data or is unable to receive a subset of pose initialization locations and the vehicle’s stored pose data is inaccurate or the vehicle 102 lacks a sufficient confidence score associated with its stored pose data, the vehicle 102 may use its last saved location to determine an estimated location 208. In such an example, the vehicle 102’s last saved location may be used as its estimated location 208 to determine a subset of pose initialization locations. As a more concrete example, if the vehicle 102 is parked in a parking garage underneath a building and both the vehicle’s saved location and pose data is inaccurate and it is unable to receive data associated with its estimated location 208 (e.g., due to a lack of network connectivity or otherwise), the vehicle 102 may search a predetermined radius around its last saved location to determine a subset of pose initialization locations. Additionally, or alternatively, the vehicle 102 may determine a subset of pose initialization locations based at least in part on a region the vehicle 102 is assigned to operate within.

As depicted in FIG. 2A, the vehicle 102 may determine a subset of pose initialization locations that includes one or more pose initialization locations. The vehicle 102 may determine, based on one or more of an accessibility, a location, and/or a distance, which one of the pose initialization locations of the subset is the most efficient/viable. A vehicle 102 may additionally or alternatively receive data from a remote operator and/or a retrievable database associated with an individual pose initialization location of the subset based on one or more of the factors listed above. For example, a vehicle 102 may receive, from a remote operator, data indicating that pose initialization location A is unavailable (e.g., due to construction, traffic, a blockage, weather), and may remove pose initialization location A from the subset, and may further instruct or otherwise notify the vehicle 102 that pose initialization location B is the most efficient/ideal of the subset due to the unavailability of location A.

At operation 212, the example processes 200 may include receiving second sensor data representing environmental features associated with the vehicle 102. For example, the vehicle 102 may receive sensor data from one or more sensors 104 representing features of the environment proximate to the vehicle 102. The vehicle 102 may use the second sensor data to localize itself. For example, the second sensor data may indicate an environmental indicator, or the vehicle 102 may compare the second sensor data with map data associated with a pose-initialization location 210. The second sensor data may include image data, radar data, lidar data, or other sensor data representing an indicator associated with an environmental feature. The indicator may be a unique identifier associated with an environmental feature and/or a global or regional pose. Examples of the unique identifier may include a retrievable identification number, quick-response (QR) code, barcode, other fiducial marker, or code transmitted by a network device. The transmitted code may use, for example, Near Field Communication (NFC), Radio Frequency Identification (RFID), Bluetooth®, Wi-Fi, a wireless local area network (WLAN), Zigbee, Z-Wave, a Long-Range Wide Area Network, Thread, or Sigfox. As a more concrete example, the vehicle 102 may receive image sensor data depicting a QR code located near the vehicle 102. The QR code may be affixed to an object associated with a global pose recorded in a database accessible to the vehicle 102, such as a database stored in vehicle memory or accessible through an application programming interface (API). The vehicle 102 may use the identified QR code and its associated global pose to localize itself and/or perform pose initialization.

The second sensor data may additionally or alternatively be associated with and/or indicate a physical object of an environment proximate the vehicle 102 that has features and/or properties that are unique to the physical object (e.g., a building, a building feature, a road feature, an art installation, a rock or similar natural object, etc.). In such an example, a vehicle 102 may receive second sensor data (e.g., lidar, radar, image, etc.) from one or more sensor(s) 104 associated with a physical object with unique or distinct physical features and may determine its estimated location 208 and/or its pose data based at least in part on the second sensor data. Additionally, or alternatively, a vehicle 102 may receive second sensor data while the vehicle is oriented in one or more directions/headings. For example, a vehicle 102 may first receive second sensor data while the vehicle 102 is in a first orientation and may additionally or alternatively receive second sensor data while the vehicle 102 is in a second orientation, the second orientation being different than the first.

In some examples, the unique identifier, indicator, or environment feature may be associated with a particular location and/or feature of the environment proximate the vehicle 102. For instance, the environment feature may be located on a permanent structure (e.g., a façade and/or exterior or interior wall/face of a building, a road surface, median, curb, shoulder, sign, billboard, post, or the like) that may be proximate the vehicle 102. For purposes of illustration and not limitation, the environment feature may be on a charging station, on the pavement surface of a parking location in front of a charging station, on an exterior-facing wall of a maintenance facility or service station, or other similar location. In at least some examples, the environment feature may be a temporary environment feature with unique features (e.g., a tree or other plant, a banner and/or sign, a flag, etc.).

In an additional or alternate example, multiple vehicles may receive second sensor data of the same or similar environment feature or indicator. In an example where multiple individual vehicles receive different second sensor data of the same unique environment feature or indicator, an individual vehicle may determine its initial pose based on a relative difference between its second sensor data and the second sensor data received by the other individual vehicles. In other examples, an indicator and/or unique identifier may be displayed in a location that a vehicle 102 may navigate (e.g., above a road, on the pavement surface at a stop light/stop sign, etc.) such that the vehicle 102 may receive second sensor data associated with the indicator/unique identifier while navigating an environment.

In an example where the vehicle determines that the second sensor data comprise an indicator or unique environment feature, example process 200 may skip to operation 226 and use a geolocation associated with the indicator or unique environment feature to determine an initial pose of the vehicle.

Turning to FIG. 2B, at operation 214, example process 200 may include determining a confidence score for a pose initialization location 210 of the subset of pose initialization locations. In some examples, each pose initialization location of the subset may have map data associated therewith. Operation 214 may be part of an iterative process to determine which pose initialization location the vehicle 102 is located at. For example, example process 200 may iteratively perform operation 214(a) and operation 214(b) using the different map data associated with each pose initialization location of the subset until the condition at operation 214 is satisfied.

Operation 214 may, in some examples, include operation 214(a), which may comprise determining a difference between a portion of the second sensor data and a surface 220 indicated by map data 216 associated with the pose initialization location 210 of the subset. In some examples, operation 214 may additionally or alternatively include operation 214(b), which may include determining a percentage of the second sensor data detected as being static object(s). As depicted in FIG. 2B, the map data 216 may include, for example, geometric data indicating a previously stored representation of surfaces in the environment at the pose initialization location 210. The geometric data may identify a location, dimensions, shape, and/or label associated with static features of the environment. In some examples, the location, dimensions, and/or shapes indicated by the geometric data may be three-dimensional. This map data may have previously been generated using a combination of sensor data collected from a vehicle and labelling of such data using machine-learned model(s) and/or human labelling. For example, a label may include a semantic label and may indicate that a portion of the geometric data is associated with a static object classification, such as a ground plane, roadway/drivable surface, building, signage, or various other static objects (e.g., mailbox, fountain, fence). The geometric data may include a data structure identifying features of the environment, such as a polygon representation, mesh representation, wireframe representation, or the like. For example, FIG. 2B includes an example of geometric data that includes mesh. A mesh may comprise vertices and faces therebetween that define surfaces in the environment. In an additional or alternate example, the map data 216 may include simpler canonic geometric shapes, such as a variety of archetypical building shapes, scenes, roadways, intersection, signage shapes, bench or other static object shapes, roadway shapes, sidewalk shapes, and/or the like. For example, a variety of different canonic signage shapes may be used to represent different signage.

Operation 214(a), may, for example, include determining a portion of the second sensor data attributable to static objects in the environment proximate the vehicle 102. For example, the depicted sensor data 218 may be part of the second sensor data, such as a lidar point that is part of a lidar point cloud. In some examples, operation 214(a) may include determining that the lidar point is associated with a static object by projecting the lidar point into an image space and determining that the projected point is within a portion of an image segmentation identified as being associated with a static object. Such an image segmentation may be determined by the perception component of the vehicle and may include an instance segmentation, semantic segmentation, or the like. By doing so, the vehicle 102 may remove (i.e., filter out) the dynamic objects in the environment (e.g., pedestrians, vehicles, animals, bicycles, etc.) to increase the accuracy of comparing the second sensor data to the one or more surfaces 220 indicated by map data 216. The portion of the second sensor data attributable to static objects may be projected onto and/or rendered into a three-dimensional voxel space, in some examples. By way of example, after receiving lidar and/or radar sensor data attributable to one or more static objects proximate the vehicle 102 as second sensor data, the second sensor data may then be projected onto a voxel space, wherein each portion of the second sensor data may be represented by an individual voxel in the voxel space. For example, in the case of lidar sensor data, each data point of a lidar point cloud may represent a measurement of distance as well as spatial coordinates (e.g., on an x-axis, y-axis, and z-axis) of the data point, which may be mapped onto the voxel space.

Once second sensor data detected as being associated with dynamic object(s) has been filtered out, operation 214(a) may further comprise determining a difference between the second sensor data and surface(s) indicated in the map data 216. For example, operation 214(a) may comprise determining an average Euclidean or other distance between portions of sensor data and a surface indicated by the map data 216. FIG. 2B depicts one such distance as a double arrow-headed line between sensor data 218 and surface 220. Additionally or alternatively determining the difference between the second sensor data and the map data may be part of an optimization that fits the second sensor data to the map data, which may comprise iteratively changing an estimated relative pose of the vehicle 102 to the map data 216 and updating an average distance between the second sensor data and the surface(s) 220 indicated in the map data 216. For example, the optimization may comprise a Monte Carlo algorithm, such as a particle filter, various SLAM (simultaneous localization and mapping) algorithms, scan matching (e.g., iterative closest point, etc.), least squares, various sensor fusion architectures (e.g., sensor fusion ecosystems, sensor fusion centers), or the like to minimize discrepancies between the second sensor data and the map data 216. In some examples, the optimization algorithm may iteratively modify the pose of the vehicle until a convergence condition is satisfied (e.g., the average Euclidean distance between points in the portion of second sensor data to their closest respective surfaces indicated in the map data is below a threshold average distance, a gradient indicating a rate of change of the average distance is less than a threshold gradient) or a number of iterations meets or exceeds a threshold number.

In some examples, the difference between a portion of the second sensor data and a surface 220 indicated by map data 216 associated with the pose initialization location 210 may be determined based at least in part on an average distance (e.g., average Euclidean distance, average Manhattan distance, etc.) between the portion of second sensor data (e.g., a lidar point, an occupied voxel (as determined using lidar, radar, stereo camera, or time-of-flight), a radar return) and the closest surface(s) 220 to such point(s) indicated by the map data 216. In some examples, this average distance or a fit value determined by an optimization algorithm, such as an R-value, may be used to determine the confidence score or may be used as the confidence score. Additionally or alternatively, such a difference may be normalized and/or standardized (e.g., min-max scaled, z-score standardized, normalized by feature scaling, etc.) as the confidence score. In some examples, the distances between the portion of second sensor data and one or more surface(s) may be normalized such that the score may be between 0 and 1. In such an example, a distance between a portion of the second sensor data and a surface that is represented by a number close to 1 may indicate a shorter distance between the portion of second sensor data and the surface 220 and a number equal to 1 indicates that the second sensor data point is collocated at the surface 220. Similarly, a longer distance between the second sensor data and a surface 220 may be represented by a number closer to 0. The aggregate distances may be averaged and/or normalized and/or distributed according to any of the techniques discussed herein. In other examples, the distances between the second sensor data and the one or more surface(s) 220 may be distributed according to one or more distribution algorithms (e.g., Gaussian, Gamma, Cauchy).

Additionally, or alternatively, operation 214 may comprise an ultrasonic or other electromagnetic handshake between a vehicle 102 and one or more ultrasonic or other electromagnetic emitters in the environment proximate the vehicle 102. For example, a vehicle 102 may receive second sensor data associated with one or more ultrasonic emitters that may be encoded with data (e.g., location data, data associated with one or more pose initialization locations). A vehicle 102 may determine a location of one or more ultrasonic emitters based at least in part map data and may use the location of the one or more ultrasonic emitters to determine a confidence score associated with a pose initialization location. In some examples, the vehicle may determine a maximum confidence score associated with a pose initialization location based at least in part on an ultrasonic handshake.

At operation 214(b), determining a confidence score associated with a pose initialization location 210 of the subset may further comprise determining a percentage of the second sensor data detected as static object(s). For example, the confidence score discussed above may be a preliminary confidence score that is multiplied by a percentage of second sensor data attributable to static objects to determine the final confidence score. This final confidence score may indicate a fit of the sensor data to the map data for the pose initialization location and, by proxy, a likelihood that the vehicle is located at or near the pose initialization location. If the percentage of the second sensor data associated with static objects is low, indicating there are few static objects in the environment proximate the pose initialization location 210, the confidence score associated with the pose initialization location 210 of the subset may be low. Conversely, if the percentage of second sensor data associated with static objects is high, indicating that there are many static objects in the environment proximate the vehicle 102, the confidence score associated with the pose initialization location 210 of the subset may be high. As a more concrete example, if a vehicle 102 is parked on a busy street and is surrounded by dozens or hundreds of people, the percentage of second sensor data associated with static objects may be relatively low, and accordingly the confidence score determined for the pose initialization location 210 of the subset may be relatively low. As depicted in FIG. 2B, static objects detected by the second sensor data may be represented by vertical hatching (or, e.g., a first color/gradient/pattern etc.), whereas dynamic objects may be represented by diagonal hatching (or, e.g., a second color/gradient/pattern).

Operation 214 of example process 200 may be repeated iteratively for each pose initialization location 210 of the subset or until the confidence score associated with one of the pose initialization locations meets or exceeds a threshold confidence score. As in previous examples and as depicted in FIG. 2A, If the subset of pose-initialization locations includes at least two pose-initialization locations, operation 214 of the example process 200 may include iteratively determining a confidence score for each pose-initialization location 210 in the subset. At operation 222, if a confidence score associated with a pose-initialization location 210 meets or exceeds a confidence-score threshold or is a maximum confidence score, the score may indicate that the vehicle 102 is likely at that pose-initialization location 210. The vehicle 102 may then perform pose initialization as described with respect to operation 226. In some examples, the vehicle 102 may stop evaluating the remaining pose-initialization locations when it obtains a maximum confidence score. A maximum confidence score may indicate with sufficient confidence that the vehicle 102 is located at the corresponding pose-initialization location 210. Alternatively, operation 222 may include comparing the confidence scores determined for the different pose-initialization locations 210 and selecting the pose-initialization location associated with the highest score for pose initialization at operation 226. This approach may be useful when the correct pose-initialization location contains numerous dynamic objects. The dynamic objects may reduce the corresponding confidence score even though the location is the correct one. In some examples, while evaluating a pose-initialization location 210, the vehicle 102 may make incremental movements to improve the confidence score. For example, the vehicle 102 may rotate or reposition itself by small angles or distances and reevaluate the sensor data to identify an optimal or improved confidence score associated with the pose-initialization location 210.

In some examples, if the confidence score determined for each pose-initialization location 210 in the subset fails to meet or exceed the confidence-score threshold, the vehicle 102 may, as shown at operation 224, be controlled based at least in part on the estimated location 208. For example, if the vehicle 102 determines that none of the pose-initialization locations 210 has a confidence score that meets the threshold, the vehicle 102 may determine that it is not currently located at any pose-initialization location in the subset. The vehicle 102 may then navigate autonomously, manually, or under remote control by a remote operator to one of the pose-initialization locations 210. Upon reaching or approaching the selected location, the vehicle 102 may again determine a confidence score for that location. In some examples, the vehicle 102 may continuously perform operation 214 while navigating to a pose-initialization location 210 or another destination. For example, while in transit, the vehicle 102 may repeatedly or iteratively: Determine a difference between a portion of the second sensor data and one or more surfaces 220 represented by map data 216; and/or determine a percentage of the second sensor data associated with static objects. The vehicle 102 may also remain stationary when none of the pose-initialization locations 210 satisfies the confidence-score threshold. While stationary, the vehicle 102 may continue evaluating the second sensor data, including the percentage of the data associated with static objects. For example, a relatively low percentage of the second sensor data may correspond to static objects, or the percentage may fail to meet a threshold percentage. This may indicate that the vehicle 102 is surrounded by pedestrians or other dynamic objects, making reliable localization difficult. In that situation, the vehicle 102 may remain stationary and continuously or repeatedly perform one or more of operations 214(a) and 214(b) until the percentage of second sensor data associated with static objects meets or exceeds the threshold percentage.

Additionally or alternatively, a vehicle 102 may determine that it is located at a pose initialization location 210 by determining that the average Euclidean distance (or another measure of comparison discussed herein, such as a confidence score) or fit value determined by an optimization algorithm is less than an average Euclidean distance threshold (or for a confidence score or fit value, above a confidence score threshold or fit value threshold) or is the minimum average Euclidean distance (or maximum confidence score) from among multiple averages/confidence scores determined by comparing the second sensor data to the map data 216 of different pose initialization locations of the subset.

Additionally, or alternatively, if a confidence score determined for a pose initialization location 210 meets or exceeds a maximum confidence score, thus indicating that the vehicle 102 has accurately determined that it is located at the pose initialization location 210, the vehicle 102 may execute a pose initialization, as discussed in more detail below. This may be the case, for example, if a vehicle 102 receives first or second sensor data associated with a QR code or another unique identifier or indicator as discussed above. In such a scenario, the vehicle 102 may not iteratively determine a confidence score for each pose initialization location 210 of the subset because the confidence score meeting or exceeding a maximum confidence score may accurately indicate that the vehicle 102 is located at the pose initialization location 210.

Additionally, or alternatively, an initial pose of a vehicle 102 may be determined based at least in part on an ultrasonic or other electromagnetic handshake, as discussed herein. For example, a vehicle 102 may receive second sensor data from one or more ultrasonic emitters in an environment proximate a vehicle 102. Such second sensor data may be sufficiently accurate and/or may comprise data that conveys an initial pose of the vehicle 102 that may meet or exceed a threshold confidence and/or accuracy threshold. The vehicle 102 may additionally or alternatively determine, based at least in part on the locations of and/or data associated with the one or more ultrasonic sensor(s), a pose relative to the one or more ultrasonic sensor(s).

At operation 226, the example process may include determining an initial pose of the vehicle 102 based at least in part on a geolocation and map data associated with a pose-initialization location 210, together with the vehicle’s relative position determined from the second sensor data. For example, the vehicle 102 may retrieve or receive a geolocation associated with the pose-initialization location 210. Using the second sensor data and map data associated with that location, the vehicle 102 may determine its relative pose with respect to the geolocation. The vehicle 102 may use a Monte Carlo method, scan-matching technique, or another localization algorithm to identify a pose that best aligns the second sensor data with the map data. The resulting pose may be represented as an offset from the geolocation associated with the pose-initialization location 210. The offset may indicate a lateral displacement, longitudinal displacement, angular displacement, and/or another positional or orientation difference. The vehicle 102 may combine the offset with the geolocation to determine a global pose, which the vehicle 102 may use as its initial pose. The geolocation may be represented by global coordinates, such as latitude and longitude, map coordinates, vehicle-centric coordinates, or another coordinate representation. The vehicle 102 may receive the geolocation from a teleoperator, a retrievable database, a simulated environment, or another source rather than determine it independently. For example, in a simulated environment, the vehicle 102 may receive Cartesian coordinates associated with a defined coordinate frame. The vehicle 102 may then determine or receive a geolocation based at least in part on the Cartesian coordinates and/or the defined coordinate frame. In other examples, the vehicle 102 may determine the initial pose without using a geolocation. Instead, the vehicle 102 may determine the initial pose directly from the map data associated with the pose-initialization location 210 and the vehicle’s relative position and orientation determined from the second sensor data.

At operation 228, example process 200 may include controlling the vehicle 102 based at least in part on the initial pose determined at operation 226, according to any of the techniques discussed herein. For example, one or more computing devices 106 of the vehicle 102 may rely at least in part on an accurate determination of the initial pose of the vehicle 102. In some examples, controlling the vehicle 102 based at least in part on the initial pose comprises using the initial pose to at least one of track progress of the vehicle 102 in the environment or determine a trajectory for controlling the vehicle based at least in part on the vehicles’ 102 initial pose. In at least one example, the localization component 120 may include hardware and/or software to receive data from the one or more sensor(s) 104 of the vehicle 102 to implement the techniques discussed herein. In such an example, the localization component 120 may determine a position, velocity, and/or orientation of the vehicle 402 (e.g., one or more of an x-, y-, z-position, roll, pitch, or yaw), according to one or more of the techniques discussed herein.

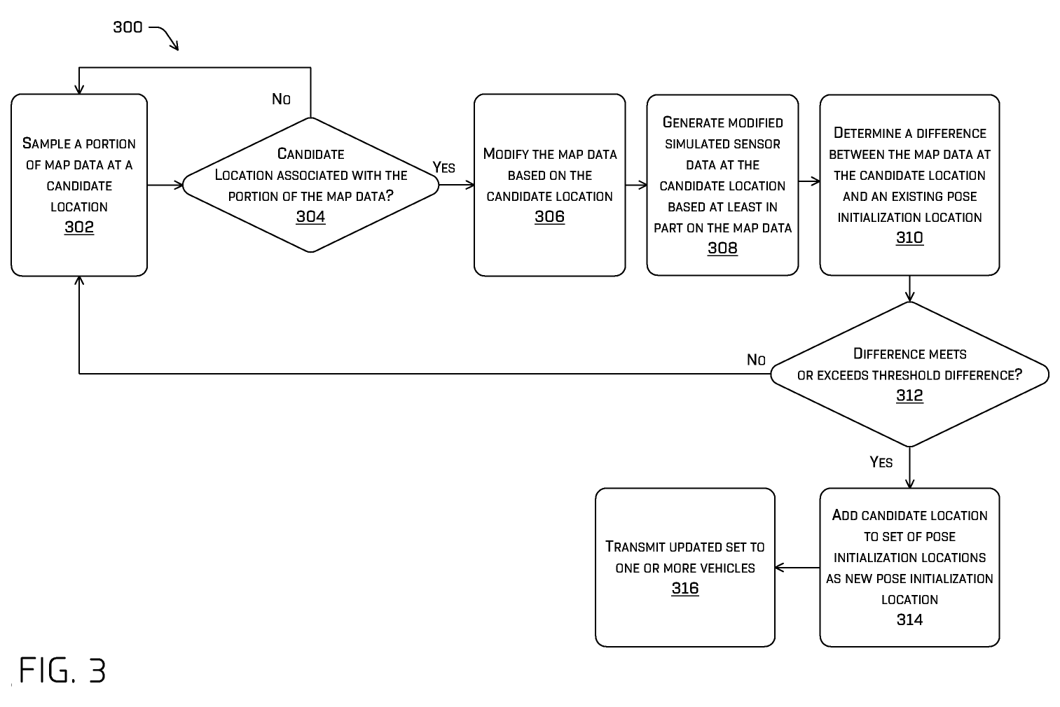

FIG. 3 illustrates a pictorial flow diagram of an example process 300 for generating a pose initialization location 210. In some examples, example process 300 may be a simulated process executed by a remote computing device for adding new pose initialization location(s) to a set of pose initialization locations. Example process 300 may be based at least in part on comparing map data at a first location or simulating sensor data at the first location with map data at a second location or a simulation of sensor data received at the second location. In such an example, the first location may be a candidate location for addition to the set of pose initialization locations and the second location may be an existing pose initialization location in the set. The comparison may be used to determine a level of distinctiveness of environment features at the candidate location from environment features at each of the existing pose initialization locations in the set. In some examples, this comparison may occur for all pose initialization locations within a region, such as an operational region to which a vehicle may be assigned (e.g., a particular city or part of a city) or based on a maximum distance at which a vehicle may search for a subset of pose initialization locations. Regarding the latter example, the comparison may be conducted between the candidate location and any pose initialization locations within twice the radius discussed above.

At operation 302, example process 300 may include sampling a portion of map data at a candidate location. For example, operation 302 may be part of iteratively sampling map data along roadways in global map data at intervals along the roadway (e.g., every 4 inches, every foot, every meter).

At operation 304, example process 300 may include determining whether a candidate parking location is associated with the portion of the map data. For example, operation 304 may comprise determining whether the map data indicates a candidate parking location where a vehicle 102 may execute a pose initialization. The candidate parking location may, for example, be in an accessible location (e.g., on the shoulder of a road, in a designated parking space, in or near a parking garage) where a vehicle 102 may navigate and park safely. A candidate parking location may be proximate a unique or distinct set of environment features and/or characteristics, which may improve the efficiency of the pose initialization execution, as discussed above. Operation 304 may include determining whether such a candidate parking location exists within a threshold distance of the candidate location. If not, example process 300 may revert to operation 302 to sample a new portion of map data at a candidate location.

At operation 306, example process 300 may include modifying the map data based on the candidate parking location. Operation 306 may comprise altering the candidate location to be a location associated with a center of the candidate parking location. Additionally, or alternatively, the map data itself may be altered to account for the potential existence of dynamic objects, environmental interference (e.g., fog, snow, rain), and/or the like, to test the suitability of the candidate location for use as a pose initialization location. For example, the features/characteristics/surroundings of the candidate parking location may be altered or otherwise modified (e.g., by adding noise, adding/removing simulated dynamic objects, removing a portion of the map data attributable to occlusions based on a field of view from the candidate location and sensor capabilities associated with the vehicle). In some examples, adding noise may comprise altering surfaces in the environment and/or masking or removing portions of surfaces in the environment. Additionally or alternatively, adding noise may be based on characteristics of one or more sensor types of the vehicle 102. For example, map data beyond an effective range of a particular sensor type may be masked out and/or noise up to that point may increase linearly and at or just before that effective range may increase logarithmically or exponentially. In some examples, the position and/or orientation of a vehicle 102 relative to the candidate parking location may be modified (e.g., turn the car x number of degrees, rotate the vehicle to face a different direction, shift the vehicle such that it is not directly in the candidate parking location, tilt/orient the vehicle at an angle off-center relative to the candidate parking location, etc.).

At operation 308, example process 300 may include generating modified simulated sensor data at the candidate parking location based at least in part on the map data. For example, operation 308 may comprise simulating sensor data to include more or fewer static and/or dynamic objects, to introduce occlusions and/or noise according to the techniques discussed herein, to create and/or remove environmental interference (e.g., rain, fog, snow), or may otherwise generate modified simulated sensor data at the candidate parking location based at least in part on the map data and one or more simulated sensor data locations and/or characteristics (e.g., field of view, orientation, attenuation, modality, general capabilities).

At operation 310, example process 300 may include determining a difference between the map data at the candidate location and the map data at an existing pose initialization location. In some examples, operation 310 may additionally or alternatively comprise simulated sensor data that may be received by the vehicle at the candidate location and simulating sensor data that may be received by the vehicle at the existing pose initialization location and comparing the two sets of sensor data. In some examples, operation 310 may comprise determining a difference between the map data at one or more of the candidate locations and an existing pose initialization location. In such an example, one or more candidate locations may be compared with each other, and may additionally or alternatively be compared with an existing candidate location to determine the difference between the map data at the one or more candidate locations and an existing pose initialization location. As a nonlimiting example, the modified map data at candidate location A and the modified map data at candidate location B may first be compared to each other to determine a difference between the two candidate locations. Additionally or alternatively, the modified map data of candidate location A and/or B may then be compared to an existing pose initialization location C to determine a difference. In other examples, the map data at a candidate location may be compared to the map data at an existing pose initialization location in isolation (i.e., one at a time), or map data of two or more candidate locations may be compared to map data of one or more existing pose initialization locations to determine one or more differences.

At operation 312, if the difference meets or exceeds a threshold difference, example process 300 may continue to operation 314; otherwise, example process 300 may discard the candidate location and return to operation 302 to determine a new candidate location. If the difference between the map data at one or more candidate locations and an existing pose initialization location meets or exceeds a threshold difference, such a difference may indicate that the candidate location is sufficiently unique and/or distinct from the existing pose initialization location.

At operation 314, example process 300 may comprise adding the candidate location (and its associated map data and/or geolocation) to the set of pose initialization locations as a new pose initialization location.

At operation 316, example process 300 may comprise transmitting an updated set of pose initialization locations to one or more vehicles. In some examples, operation 316 may comprise transmitting such pose initialization locations to one or more vehicles as they are added, once a threshold number of new pose initialization locations are added, or the like. Additionally, or alternatively, operation 316 may transmit the updated set (or at least the newest additions) responsive to a request received from a vehicle.

Example process 300 may be iteratively repeated with one or more portions of map data and one or more candidate parking locations in each portion of map data to determine an updated set of pose initialization locations. Additionally, or alternatively, example process 300 may be executed at least in part in a simulated environment.

### EXAMPLE SYSTEM

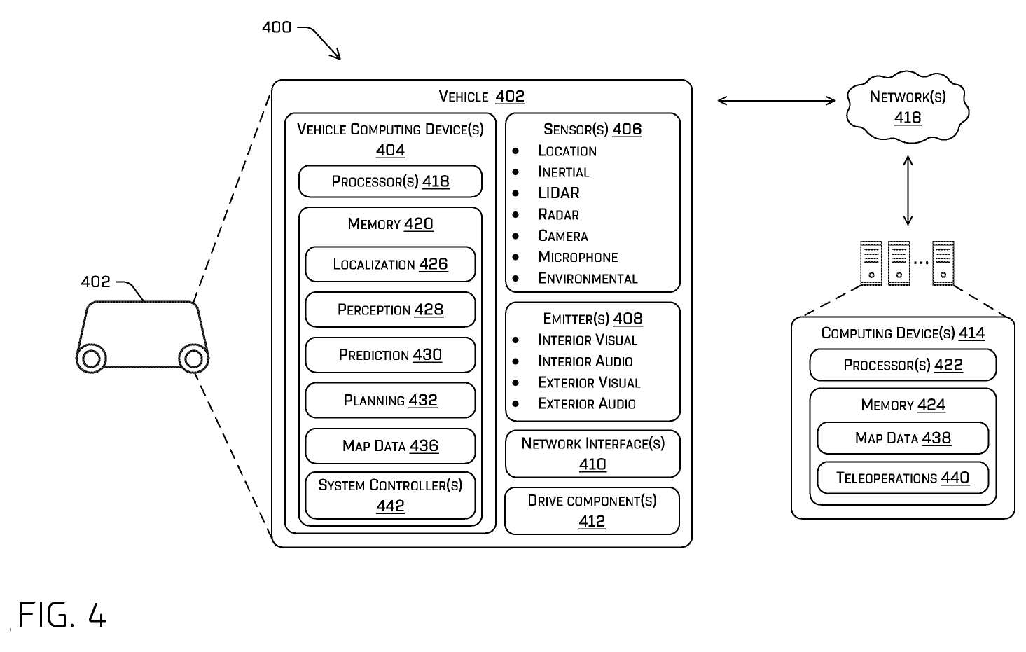

FIG. 4 illustrates a block diagram of an example system 400 that implements the techniques discussed herein. In some instances, the example system 400 may include a vehicle 402, which may represent the vehicle 102 in FIG. 1. In some instances, the vehicle 402 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 402 may be a fully or partially autonomous vehicle having any other level or classification. Moreover, in some instances, the techniques described herein may be usable by non-autonomous vehicles as well. In some examples, the vehicle 401 may represent vehicle 102.

The vehicle 402 may include a vehicle computing device(s) 404, sensor(s) 406, emitter(s) 408, network interface(s) 410, and/or drive component(s) 412. Vehicle computing device(s) 404 may represent computing device(s) 106 and sensor(s) 406 may represent sensor(s) 104. The system 400 may additionally or alternatively comprise computing device(s) 414.

In some instances, the sensor(s) 406 may represent sensor(s) 104 and may include lidar sensors, radar sensors, ultrasonic transducers, sonar sensors, location sensors (e.g., global positioning system (GPS), compass, etc.), inertial sensors (e.g., inertial measurement units (IMUs), accelerometers, magnetometers, gyroscopes, etc.), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors, etc.), etc. The sensor(s) 406 may include multiple instances of each of these or other types of sensors. For instance, the radar sensors may include individual radar sensors located at the corners, front, back, sides, and/or top of the vehicle 402. As another example, the cameras may include multiple cameras disposed at various locations about the exterior and/or interior of the vehicle 402. The sensor(s) 406 may provide input to the vehicle computing device(s) 404 and/or to computing device(s) 414.

The vehicle 402 may also include emitter(s) 408 for emitting light and/or sound, as described above. The emitter(s) 408 in this example may include interior audio and visual emitter(s) to communicate with passengers of the vehicle 402. By way of example and not limitation, interior emitter(s) may include speakers, lights, signs, display screens, touch screens, haptic emitter(s) (e.g., vibration and/or force feedback), mechanical actuators (e.g., seatbelt tensioners, seat positioners, headrest positioners, etc.), and the like. The emitter(s) 408 in this example may also include exterior emitter(s). By way of example and not limitation, the exterior emitter(s) in this example include lights to signal a direction of travel or other indicator of vehicle action (e.g., indicator lights, signs, light arrays, etc.), and one or more audio emitter(s) (e.g., speakers, speaker arrays, horns, etc.) to audibly communicate with pedestrians or other nearby vehicles, one or more of which comprising acoustic beam steering technology.

The vehicle 402 may also include network interface(s) 410 that enable communication between the vehicle 402 and one or more other local or remote computing device(s). For instance, the network interface(s) 410 may facilitate communication with other local computing device(s) on the vehicle 402 and/or the drive component(s) 412. Also, the network interface(s) 410 may additionally or alternatively allow the vehicle to communicate with other nearby computing device(s) (e.g., other nearby vehicles, traffic signals, etc.). The network interface(s) 410 may additionally or alternatively enable the vehicle 402 to communicate with computing device(s) 414. In some examples, computing device(s) 414 may comprise one or more nodes of a distributed computing system (e.g., a cloud computing architecture).

The network interface(s) 410 may include physical and/or logical interfaces for connecting the vehicle computing device(s) 404 to another computing device or a network, such as network(s) 416. For example, the network interface(s) 410 may enable Wi-Fi-based communication such as via frequencies defined by the IEEE 802.11 standards, short range wireless frequencies such as ultra-high frequency (UHF) radio (e.g., Bluetooth®), cellular communication (e.g., 2G, 6G, 4G, 4G LTE, 5G, etc.), or any suitable wired or wireless communications protocol that enables the respective computing device to interface with the other computing device(s). In some instances, the vehicle computing device(s) 404 and/or the sensor(s) 406 may send sensor data, via the network(s) 416, to the computing device(s) 414 at a particular frequency, after a lapse of a predetermined period of time, in near real-time, etc.

In some examples, the vehicle 402 may include one or more drive components 412. In some examples, the vehicle 402 may include a single drive component 412. The drive component(s) 412 may include one or more sensors configured to detect operating conditions of the drive component(s) 412 and/or characteristics of the environment surrounding the vehicle 402. By way of example and not limitation, the sensors associated with the drive component(s) 412 may include: Wheel encoders, such as rotary encoders, configured to detect rotation of wheels associated with the drive component(s) 412; Inertial sensors, such as inertial measurement units, accelerometers, gyroscopes, and magnetometers, configured to measure motion, orientation, and/or acceleration of the drive component(s) 412; Cameras or other image sensors; Ultrasonic sensors configured to acoustically detect objects near the drive component(s) 412; Lidar sensors; and/or Radar sensors. Some sensors, such as wheel encoders, may be dedicated to the drive component(s) 412. In some examples, the sensors associated with the drive component(s) 412 may overlap with, supplement, or provide redundant information relative to corresponding vehicle systems, such as sensor(s) 406.

The drive component(s) 412 may include various vehicle systems, such as: A high-voltage battery; A motor configured to propel the vehicle 402; An inverter configured to convert direct-current power from the battery into alternating-current power for the motor and/or other vehicle systems; A steering system, including a steering motor and steering rack, which may be electrically actuated; A braking system, including hydraulic and/or electric actuators; A suspension system, including hydraulic and/or pneumatic components; A stability-control system configured to distribute braking forces to mitigate loss of traction and maintain vehicle control; A heating, ventilation, and air-conditioning (HVAC) system; Lighting systems, such as headlamps and taillamps, configured to illuminate the exterior environment; and Other systems, such as a cooling system, safety systems, an onboard charging system, a charge port, and electrical components including a DC/DC converter, high-voltage junction, and high-voltage cables. The drive component(s) 412 may also include a drive-component controller configured to receive and preprocess data from the associated sensors and control operation of the vehicle systems. In some examples, the drive-component controller may include one or more processors and memory communicatively coupled to the processors. The memory may store software components configured to perform various drive-component functions. Additionally, the drive component(s) 412 may include one or more communication connections that enable the respective drive component(s) 412 to communicate with other local or remote computing devices.

The vehicle computing device(s) 404 may include one or more processors 418 and memory 420 communicatively coupled to the processor(s) 418. In some examples, the memory 420 may correspond to memory 108 described above. The computing device(s) 414 may also include one or more processors 422, memory 424, map data 438, and/or a teleoperations component 440. The processor(s) 418 and/or 422 may be any suitable processors configured to execute instructions, process data, and perform operations described herein. By way of example and not limitation, the processor(s) 418 and/or 422 may include one or more central processing units (CPUs), graphics processing units (GPUs), integrated circuits such as application-specific integrated circuits (ASICs), programmable logic devices such as field-programmable gate arrays (FPGAs), and/or other devices or portions of devices configured to process electronic data. The processor(s) 418 and/or 422 may transform the electronic data into other electronic data, which may be stored in registers, memory, or another suitable storage medium.

Memory 420 and/or 424 may be examples of non-transitory computer-readable media. The memory 420 and/or 424 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 420 and/or memory 424 may store a localization component 426, perception component 428, prediction component 430, planning component 432, map data 436, and/or system controller(s) 442. Perception component 428 may represent perception component 110, prediction component 430 may represent prediction component 112, planning component 432 may represent planning component 114, and/or map data 436 may represent map data 118.

In at least one example, the localization component 426 may include hardware and/or software configured to receive data from the sensor(s) 406 and determine a position, velocity, and/or orientation of the vehicle 402. The position and orientation may be represented by one or more of an x-position, y-position, z-position, roll, pitch, or yaw. The localization component 426 may include, request, and/or receive one or more maps 434, such as map data representing an environment. Using the map data and sensor data, the localization component 426 may continuously determine the location, velocity, and/or orientation of the autonomous vehicle within the environment. In some examples, the localization component 426 may use one or more localization and mapping techniques, including simultaneous localization and mapping (SLAM), calibration, localization and mapping simultaneously (CLAMS), relative SLAM, bundle adjustment, nonlinear least-squares optimization, or similar techniques. These techniques may process image data, lidar data, radar data, inertial measurement unit (IMU) data, global positioning system (GPS) data, wheel-encoder data, and/or other sensor data to determine the location, pose, and/or velocity of the autonomous vehicle. The localization component 426 may provide localization data to other components of the vehicle 402, including data used to determine an initial position or pose of the autonomous vehicle as described herein. For example, the localization component 426 may provide the planning component 432 with a location and/or orientation of the vehicle 402 relative to the environment, together with sensor data associated with the location and/or orientation.

In some examples, the perception component 428 may detect objects in the environment surrounding the vehicle 402. For example, the perception component 428 may determine that an object is present, classify the object by determining an associated object type, and segment sensor data and/or another representation of the environment to identify portions associated with the object and/or object type. The perception component 428 may also determine characteristics associated with detected objects. Such characteristics may include a track representing current, predicted, and/or previous positions, headings, velocities, and/or accelerations of the objects. In some examples, the perception component 428 may generate a top-down representation of the environment. The representation may encode classifications, positions, orientations, velocities, accelerations, and/or other states of detected objects, as well as map data and/or general environmental-state data. For example, the top-down representation may be an image containing embedded data. Values associated with different pixel channels may encode perception data, map data, and/or other environmental information. The top-down representation may provide a bird’s-eye-view image representing features of the environment, such as detected objects and map features. The map features may indicate roadway shapes and extents, signage, static objects, and/or other environmental characteristics. Examples of such top-down environmental representations are described in U.S. Patent Application Publication No. 2021/0181758, filed Jan. 30, 2020, the entirety of which is incorporated herein by reference for all purposes. Data determined by the perception component 428 is referred to herein as perception data.

The prediction component 430 may predict a future state of an object in the environment surrounding the vehicle 402. The future (predicted) state may include a predicted position and/or orientation of an object and/or a predicted trajectory of the object, which may indicate a predicted series of or continuous indication of position and/or orientation of the object. In some examples, the predicted position and/or orientation and/or predicted trajectory may be time-invariant (without regard to time), although in another example, the predicted position and/or orientation and/or predicted trajectory may be time-variant. In the latter example, a pose of the trajectory and/or the predicted pose may be associated with a future time. Accordingly, the predicted trajectory may inherently encode vehicle velocity based on the distance covered by the predicted poses in time. Data determined by the prediction component 430 is referred to as prediction data. In some examples, the prediction component 430 may determine a top-down representation of a predicted future state of the environment. For example, the top-down representation may be an image with additional data embedded therein, such as where various channel pixel values encode the prediction data discussed herein.

The planning component 432 may receive a location and/or orientation of the vehicle 402 from the localization component 426 and/or perception data from the perception component 428 and may determine instructions for controlling operation of the vehicle 402 based at least in part on any of this data. In some examples, determining the instructions may comprise determining the instructions based at least in part on a format associated with a system with which the instructions are associated (e.g., first instructions for controlling motion of the autonomous vehicle may be formatted in a first format of messages and/or signals (e.g., analog, digital, pneumatic, kinematic) that the system controller(s) 442 and/or drive component(s) 412 may parse/cause to be carried out, second instructions for the emitter(s) 408 may be formatted according to a second format associated therewith).

Although localization component 426, perception component 428, prediction component 430, planning component 432, map(s) 434, and/or system controller(s) 442 are illustrated as being stored in memory 420, any of these components may include processor-executable instructions, machine-learned model(s) (e.g., a neural network), and/or hardware and all or part of any of these components may be stored on memory 420 or configured as part of computing device(s) 414.

As described herein, the localization component 426, the perception component 428, the prediction component 430, planning component 432, and/or other components of the system 400 may comprise one or more ML models. For example, the localization component 426, the perception component 428, the prediction component 430, and/or the planning component 432 may each comprise different ML model pipelines. In some examples, an ML model may comprise a neural network. An exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine-learning, which can refer to a broad class of such algorithms in which an output is generated based on learned parameters.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 6 (ID6), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, Hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, EfficientNet, PointNet, Xception, and the like or visual transformers (ViTs), such as ConvNeXt.

Memory 420 may additionally or alternatively store one or more system controller(s) 442, which may be configured to control steering, propulsion, braking, safety, emitters, communication, and other systems of the vehicle 402. These system controller(s) 442 may communicate with and/or control corresponding systems of the drive component(s) 412 and/or other components of the vehicle 402. For example, the planning component 432 may generate instructions based at least in part on perception data generated by the perception component 428, which the trajectory verification component 432 may validate and/or transmit to the system controller(s) 442. The system controller(s) 442 may control operation of the vehicle 402 based at least in part on the instructions received from the planning component 432. In some examples, these instructions may be based at least in part on map data generated according to the techniques discussed herein. In some examples, a trajectory verification component may replace instructions generated by the planning component 432 with alternate instructions associated with a contingent trajectory such as, for example, a contingent trajectory that may specify an alternate maneuver, and/or the like.

In some examples, remote computing device(s) 414 may determine map data 438 based at least in part on log data received from one or more vehicles. For example, the remote computing device(s) 414 may determine the map data 438 using operations discussed in U.S. Patent No. 11,657,719, filed on Dec. 18, 2020, the entirety of which is incorporated herein for all purposes. The map data 438, or a portion thereof, may then be transmitted to vehicle 402 as map data 436. For example, map data 436 may be a portion of map data 438, such as map data associated with a region in which the vehicle 402 is assigned to operation.

In some examples, the teleoperations component 440 may include hardware and/or software for providing instructions and/or feedback to the vehicle 402, as discussed in more detail in U.S. Patent No. 11,891,088, filed Jun. 14, 2021, the entirety of which is incorporated by reference herein for all intents and purposes. The teleoperations component 440 may present a user interface (e.g., a graphical user interface, an auditory interface, a tactile feedback component) to a teleoperator (e.g., a human user, an artificial intelligence component) that comprises sensor data, perception data, a representation of the simulation discussed herein, and/or like. For example, the teleoperations component 440 may receive an indication that the vehicle 402 was unable to determine an estimated location of the vehicle or failed to determine a sufficient confidence score to indicate that the vehicle 402 is located at a pose initialization location. In such an example, a teleoperator may provide an indication of the vehicle’s location for the vehicle to use as an estimated location, may indicate that the vehicle is located at a particular pose initialization location (e.g., which may be helpful if the vehicle is located at a pose initialization location but the confidence score associated therewith was low due to a high number of dynamic objects in the environment, a may indicate a nearest pose initialization location to the vehicle, and/or to guide the vehicle to a pose initialization location.

It should be noted that while FIG. 4 is illustrated as a distributed system, in alternative examples, components of the vehicle 402 may be associated with the computing device(s) 414 and/or components of the computing device(s) 414 may be associated with the vehicle 402. That is, the vehicle 402 may perform one or more of the functions associated with the computing device(s) 414, and vice versa.

### EXAMPLE CLAUSES

A. A system comprising: one or more processors; and a non-transitory memory storing processor-executable instructions that, when executed by the one or more processors, cause the system to perform operations comprising: detecting a pose initialization trigger event; determining, based at least in part on first sensor data or a stored pose, an estimated location of a vehicle; determining, based at least in part on the estimated location, a subset of pose initialization locations; receiving second sensor data indicating environment features of an environment proximate the vehicle; determining a first confidence score for a first pose initialization location of the subset of pose initialization locations, wherein determining the first confidence score comprises: determining a difference between a portion of the second sensor data and a surface indicated by map data associated with the first pose initialization location, and determining a percentage of the second sensor data detected as static objects using the second sensor data; determining that the vehicle is located at the first pose initialization location based at least in part on at least one determining that the first confidence score meets or exceeds a confidence threshold or that the first confidence score is a maximum confidence score among a set of confidence scores determined for the subset of pose initialization locations; determining, based at least in part on a geolocation and the map data associated with the first pose initialization location and a relative position of the vehicle determined based at least in part on the second sensor data and the map data, an initial pose of the vehicle; and controlling the vehicle based at least in part on the initial pose.
B. The system as recited in paragraph A, wherein determining the subset of pose initialization locations based at least in part on the estimated location comprises determining the subset of pose initialization locations from among a superset of pose initialization locations based at least in part on one or more of: determining that the subset of pose initialization locations is within a threshold distance of the estimated location, or determining that the subset of pose initialization locations are indicated in a database as being available.
C. The system as recited in either paragraph A or B, wherein the pose initialization trigger event comprises one or more of: determining a charge event based at least in part on third sensor data; determining an impact event based at least in part on the third sensor data; determining a sensor failure or impairment based at least in part on the third sensor data; receiving an indication that a reboot event occurred; receiving an indication that a repair or diagnostic event occurred or receiving an instruction to perform a repair or diagnostic event; determining a passage of time that exceeds a threshold amount of time based at least in part on the third sensor data; receiving an indication that a mode of operation of the vehicle changed; or receiving an instruction to initialize a pose of the vehicle from a remote computing device.
D. The system as recited in any one of paragraphs A–C, wherein the first sensor data or the second sensor data comprises data attributable to an indicator, the indicator comprising a unique identifier.
E. The system as recited in paragraph D, wherein the unique identifier comprises one or more of: a retrievable identification number; a quick-response (QR) code; a barcode; a physical object having physical properties unique to the physical object; an indication of signal strength from two or more network devices; data received from one or more emitters; or a network device transmitted code.
F. The system as recited in any one of paragraphs A–E, wherein the subset of pose initialization locations comprises one or more pose initialization locations within a threshold radius of the estimated location of the vehicle.
G. One or more non-transitory computer-readable media storing processor-executable instructions that, when executed by one or more processors, cause the one or more processors to perform operations comprising: receiving sensor data at a vehicle; determining, based at least in part on the sensor data, that the vehicle is located within a threshold distance of a first predetermined location from among a set of predetermined initialization locations; determining, based at least in part on the sensor data and the first predetermined location, an initial pose of the vehicle; and controlling the vehicle based at least in part on the initial pose.
H. The one or more non-transitory computer-readable media of paragraph G, the operations further comprising determining an estimated location of the vehicle wherein determining the estimated location comprises one or more of: determining the estimated location of the vehicle based at least in part on a location of the vehicle indicated in the sensor data; determining a relative position of the vehicle to an indicator identified by the sensor data; determining a region associated with operation of the vehicle; or determining that a stored pose is associated with a cessation of a mode or operation of the vehicle at a previous time.
I. The one or more non-transitory computer-readable media of either paragraph G or H, the operations further comprising determining a difference between a portion of the sensor data and a surface indicated by map data, wherein determining the difference comprises: determining a portion of the sensor data attributable to static objects; determining, based at least in part on optimizing the portion of sensor data attributable to static objects with the map data associated with the first predetermined location, an optimized representation of the map data; and determining, based at least in part on the optimized representation of the map data, an average distance between the portion of the sensor data attributable to static objects and the surface indicated by the map data.
J. The one or more non-transitory computer-readable media of any one of paragraphs G–I, wherein controlling the vehicle based at least in part on the initial pose comprises using the initial pose to at least one of track progress of the vehicle in an environment or determine a trajectory for controlling the vehicle based at least in part on the initial pose or a subsequent pose of the vehicle determined based at least in part on the initial pose.
K. The one or more non-transitory computer-readable media of any one of paragraphs G–J, the operations further comprising determining an estimated location of the vehicle, and wherein the set of predetermined initialization locations comprises one or more initialization locations within a threshold radius of the estimated location.
L. The one or more non-transitory computer-readable media of any one of paragraphs G–K, wherein determining that the vehicle is located within a threshold distance of a first predetermined location from among the set of predetermined initialization locations further comprises: determining a difference between a portion of the sensor data and a surface indicated by map data associated with a first initialization location of the set of predetermined initialization locations; and determining that the vehicle is located at the first initialization location based at least in part on determining that at least one of the difference is below a threshold difference or the difference is a minimum difference from among a set of differences determined for the set of predetermined initialization locations.
M. The one or more non-transitory computer-readable media of any one of paragraphs G–L, further comprising detecting a pose initialization trigger event, the pose initialization trigger event comprising one or more of: determining a charge event based at least in part on third sensor data; determining an impact event based at least in part on the third sensor data; determining a sensor failure or impairment based at least in part on the third sensor data; receiving an indication that a reboot event occurred; receiving an indication that a repair or diagnostic event occurred or receiving an instruction to perform a repair or diagnostic event; determining a passage of time that exceeds a threshold amount of time based at least in part on the third sensor data; receiving an indication that a mode of operation of the vehicle changed; or receiving an instruction to initialize a pose of the vehicle from a remote computing device.
N. The one or more non-transitory computer-readable media of any one of paragraphs G–M, wherein the sensor data comprises an indication of or is used to determine one or more of: a retrievable identification number; a quick-response (QR) code; a barcode; a physical object having physical properties unique to the physical object; an indication of signal strength from two or more network devices; data associated with an indicator; data received from one or more emitters; or a network device transmitted code.
O. A method comprising: receiving sensor data at a vehicle; determining, based at least in part on the sensor data, that the vehicle is located within a threshold distance of a first predetermined location from among a set of predetermined initialization locations; determining, based at least in part on the sensor data and the first predetermined location, an initial pose of the vehicle; and controlling the vehicle based at least in part on the initial pose.
P. The method of paragraph O, further comprising determining an estimated location of the vehicle, wherein determining the estimated location of the vehicle comprises one or more of: determining the estimated location of the vehicle based at least in part on a location of the vehicle indicated in the sensor data; determining a relative position of the vehicle to an indicator identified by the sensor data; determining a region associated with operation of the vehicle; or determining that a stored pose is associated with a cessation of a mode or operation of the vehicle at a previous time.
Q. The method of either paragraph O or P further comprising determining a difference between a portion of the sensor data and a surface indicated by map data, wherein determining the difference comprises: determining a portion of the sensor data attributable to static objects; determining, based at least in part on optimizing the portion of sensor data attributable to static objects with the map data associated with the first predetermined location, an optimized representation of the map data; and determining, based at least in part on the optimized representation of the map data, an average distance between the portion of the sensor data attributable to static objects and the surface indicated by the map data.
R. The method of any one of paragraphs O–Q, wherein controlling the vehicle based at least in part on the initial pose comprises using the initial pose to at least one of track progress of the vehicle in an environment or determine a trajectory for controlling the vehicle based at least in part on the initial pose or a subsequent pose of the vehicle determined based at least in part on the initial pose.
S. The method of any one of paragraphs O–R, wherein the set of predetermined initialization locations comprises one or more pose initialization locations within a threshold radius of an estimated location of the vehicle.
T. The method of any one of paragraphs O–S, wherein the sensor data comprises an indication of or is used to determine one or more of: a retrievable identification number; a quick-response (QR) code; a barcode; a physical object having physical properties unique to the physical object; an indication of signal strength from two or more network devices; data received from one or more emitters; a unique identifier; or a network device transmitted code.

While the example clauses described above are described with respect to one particular implementation, it should be understood that, in the context of this document, the content of the example clauses can also be implemented via a method, device, system, computer-readable medium, and/or another implementation. Additionally, any of examples A–T may be implemented alone or in combination with any other one or more of the examples A–T.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow graphs, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural. When referring to a collection of items as a “set,” it should be understood that the definition may include, but is not limited to, the common understanding of the term in mathematics to include any number of items including a null set (0), 1, 2, 3, … up to and including an infinite set.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system for facilitating a pose initialization of a vehicle, the system comprising:
one or more processors; and
one or more non-transitory computer-readable media storing computer-executable instructions that, when executed by the one or more processors, cause the one or more processors to perform operations comprising:
receiving, from the vehicle via a network, first data associated with an estimated location of the vehicle;
determining, based at least in part on the estimated location, a set of candidate pose initialization locations;
transmitting, to the vehicle via the network, the set of candidate pose initialization locations and map data associated with individual pose initialization locations of the set of candidate pose initialization locations; and
receiving, from the vehicle, second data associated with the pose initialization performed using a first pose initialization location of the set of candidate pose initialization locations.

2. The system of claim 1, the operations further comprising:
determining that the second data comprises a second indication that a confidence score associated with the pose initialization fails to meet or exceed a threshold confidence score;
determining, based at least in part on the second indication, an optimal pose initialization location of the set of candidate pose initialization locations; and
transmitting, to the vehicle via the network, the optimal pose initialization location.

3. The system of claim 2, wherein determining the optimal pose initialization location is based at least in part on at least one of:
a distance between the vehicle and individual pose initialization locations of the set of candidate pose initialization locations;
an accessibility of individual pose initialization locations of the set of candidate pose initialization locations; or
an availability of individual pose initialization locations of the set of candidate pose initialization locations.

4. The system of claim 3, the operations further comprising transmitting, to the vehicle via the network, data for controlling the vehicle based at least in part on the optimal pose initialization location.

5. The system of claim 1, wherein the set of candidate pose initialization locations is further determined based at least in part on a superset of pose initialization locations stored in a database associated with the system.

6. The system of claim 1, the first data comprising at least one of:
global positioning satellite (GPS) data;
a stored location of the vehicle indicating a last location determined by the vehicle; or
triangulation data received from one or more network devices based at least in part on a signal strength from the one or more network devices.

7. The system of claim 1, wherein the map data associated with individual pose initialization locations comprises geometric data indicating a previously stored representation of surfaces in an environment of the individual pose initialization location.

8. A method comprising:
receiving sensor data associated with an environment of a vehicle;
receiving map data associated with the environment;
detecting, based at least in part on the sensor data, a landmark in the environment;
determining, based at least in part on map data and the sensor data, that the landmark corresponds to a known landmark associated with the map data;
determining, based at least in part on the sensor data and the map data, a relative position of the vehicle to the landmark;
determining, based at least in part on the relative position of the vehicle to the landmark and a first geolocation associated with the known landmark, a second geolocation of the vehicle; and
causing the vehicle to be controlled based at least in part on the second geolocation.

9. The method of claim 8, wherein the landmark comprises a physical object having physical properties unique to the physical object.

10. The method of claim 8, wherein the landmark comprises a visual indicator, the visual indicator comprising one or more of:
a quick-response (QR) code;
a barcode;
a radio frequency identification (RFID) tag; or
a fiducial marker.

11. The method of claim 8, further comprising:
detecting an initialization trigger event comprising at least one of:
a charge event;
an impact event;
a sensor failure or impairment;
a first indication that a reboot event occurred;
a second indication that a mode of operation of the vehicle changed; or
an instruction to initialize the second geolocation of the vehicle from a remote computing device.

12. The method of claim 8, further comprising:
determining, based at least in part on a comparison of the sensor data to the map data associated with the known landmark, a confidence score associated with a likelihood that the landmark corresponds to the known landmark, wherein determining the second geolocation of the vehicle is further based at least in part on the confidence score meeting or exceeding a threshold.

13. The method of claim 8, wherein determining the second geolocation of the vehicle comprises determining a lateral offset, a longitudinal offset, or an angular offset of the vehicle relative to the first geolocation associated with the known landmark.

14. The method of claim 8, further comprising:
filtering, from the sensor data, a portion of the sensor data associated with dynamic objects in the environment prior to determining the relative position of the vehicle to the known landmark.

15. One or more non-transitory computer-readable media storing computer-executable instructions that, when executed by one or more processors, cause the one or more processors to perform operations comprising:
sampling map data at a candidate location in an environment;
determining whether a candidate parking location is associated with the candidate location;
determining a difference between the map data at the candidate location and map data at an existing pose initialization location of a set of pose initialization locations;
determining that the difference meets or exceeds a threshold difference, the threshold difference indicating that the candidate location is sufficiently distinct from the existing pose initialization location;
adding, based at least in part on the difference meeting or exceeding the threshold difference, the candidate location to the set of pose initialization locations; and
transmitting an updated set of pose initialization locations to one or more vehicles operating in the environment.

16. The one or more non-transitory computer-readable media of claim 15, the operations further comprising:
modifying the map data at the candidate location prior to determining the difference.

17. The one or more non-transitory computer-readable media of claim 16, wherein modifying the map data comprises at least one of:
adding noise to the map data;
adding or removing simulated dynamic objects;
removing a portion of the map data attributable to occlusions based on a field of view from the candidate location and sensor capabilities associated with a vehicle; or
modifying a position or orientation of a simulated vehicle relative to the candidate location.

18. The one or more non-transitory computer-readable media of claim 15, the operations further comprising:
generating first simulated sensor data at the candidate location based at least in part on the map data; and
determining the difference based at least in part on comparing the first simulated sensor data at the candidate location to second simulated sensor data at the existing pose initialization location.

19. The one or more non-transitory computer-readable media of claim 15, wherein sampling map data at the candidate location comprises iteratively sampling map data along a roadway in the environment at defined intervals.

20. The one or more non-transitory computer-readable media of claim 15, wherein the candidate parking location comprises one or more of:
a first location on a shoulder of a road;
a designated parking space;
a second location in or proximate a parking garage; or
a third location proximate a charging station or maintenance facility.
